(19) United States
(12) Patent Application Publication
(10) Pub. No.: US 2017/0182934 A1
(43) Pub. Date: Jun. 29, 2017

(54) VEHICLE PROJECTION CONTROL SYSTEM AND METHOD OF CONTROLLING IMAGE PROJECTION

(71) Applicant: Mitsubishi Electric Corporation, Tokyo (JP)

(72) Inventors: Hidekazu ARITA, Tokyo (JP); Mitsuo SHIMOTANI, Tokyo (JP)

(73) Assignee: Mitsubishi Electric Corporation, Tokyo (JP)

(21) Appl. No.: 15/313,013

(22) PCT Filed: Sep. 1, 2014
(86) PCT No.: PCT/JP2014/072912

§ 371 Date: Nov. 21, 2016

(51) Int. Cl. B60Q 1/50; G06T 7/70; H04N 9/31

(52) U.S. Cl. CPC B60Q 1/503; H04N 9/3185; H04N 9/3194; G06T 7/70; G06T 2207/30252

(57) ABSTRACT

A vehicle projection control device of the present invention includes: a projection controller that controls a projection device to project an image to a surrounding of an own vehicle; a connection point detector that detects a connection point between a road on which the own vehicle is traveling (own vehicle traveling road) and another road (connected road) connected to the own vehicle traveling road; and an overlapping traveling area detector that detects an overlapping traveling area at the connection point. The overlapping traveling area is an area that permits traveling of both another vehicle to enter the connection point from a connected road and the own vehicle. The projection controller projects an image to the overlapping traveling area detected by the overlapping traveling area detector by using the projection device.

### TECHNICAL FIELD

The present invention relates to a projection control system that projects an image to a surrounding of a vehicle.

### BACKGROUND ART

A technique of projecting light or images indicating various types of information to a road surface in a surrounding of an own vehicle using a projection device such as a laser, a projector, or a headlight has been suggested (see patent literatures 1 to 5 listed below, for example).

### PRIOR ART LITERATURES

### Patent Literatures

Patent Literature 1: Japanese Patent Application Laid-Open No. 2008-007079

Patent Literature 2: Japanese Patent Application Laid-Open No. 2008-287669

Patent Literature 3: Japanese Patent Application Laid-Open No. 2008-009941

Patent Literature 4: Japanese Patent Application Laid-Open No. 2005-157873

Patent Literature 5: Japanese Patent Application Laid-Open No. 2013-237427

### SUMMARY OF INVENTION

### Problems to be Solved by Invention

For example, by projecting an image to a road surface at an intersection by using a projection device of an own vehicle, a driver of another vehicle on another road connected to this intersection can be notified of the existence of the own vehicle. The convenience of the projection device will be enhanced if a specific area at the intersection to watch out for can be indicated particularly.

The present invention has been made in view of the aforementioned problem to be solved. It is an object of the present invention to provide a vehicle projection control system and a method of controlling image projection employed by this system capable of indicating an area to watch out for during driving at a connection point between a road on which an own vehicle is traveling and another road.

### Means of Solving Problems

A vehicle projection control system according to the present invention includes: a projection controller that controls a projection device to project an image to a surrounding of an own vehicle; a connection point detector that detects a connection point between an own vehicle traveling road on which the own vehicle is traveling and a connected road that is another road connected to the own vehicle traveling road; and an overlapping traveling area detector that detects an overlapping traveling area at the connection point. The overlapping traveling area is an area that permits traveling of both another vehicle to enter the connection point from a connected road and the own vehicle. The projection controller projects an image to the overlapping traveling area detected by the overlapping traveling area detector by using the projection device.

### Advantageous Effect of Invention

At a connection point such as an intersection, an area that permits traveling of both an own vehicle and another vehicle (overlapping traveling area) is also an area in which collision of the own vehicle with the other vehicle is probable, so that it is to watch out for particularly during driving. In the vehicle projection control system according to the present invention, an image is projected to an area that permits traveling of a vehicle. This allows a driver of the own vehicle and a driver of the other vehicle to recognize the overlapping traveling area easily based on the position of the projected image.

These and other objects, features, aspects and advantages of the present invention will become more apparent from the following detailed description and the accompanying drawings.

### BRIEF DESCRIPTION OF DRAWINGS

FIG. 1 is a block diagram showing the structure of a vehicle projection control system according to a first embodiment.

FIG. 2 explains the operation of a vehicle projection control device according to the first embodiment.

FIG. 3 explains the operation of the vehicle projection control device according to the first embodiment.

FIG. 4 explains the operation of the vehicle projection control device according to the first embodiment.

FIG. 5 explains the operation of the vehicle projection control device according to the first embodiment.

FIG. 6 explains the operation of the vehicle projection control device according to the first embodiment.

FIG. 7 explains the operation of the vehicle projection control device according to the first embodiment.

FIG. 8 explains the operation of the vehicle projection control device according to the first embodiment.

FIG. 9 explains the operation of the vehicle projection control device according to the first embodiment.

FIG. 10 explains the operation of the vehicle projection control device according to the first embodiment.

FIG. 11 explains the operation of the vehicle projection control device according to the first embodiment.

FIG. 12 explains the operation of the vehicle projection control device according to the first embodiment.

FIG. 13 is a flowchart showing the operation of the vehicle projection control device according to the first embodiment.

FIG. 14 is a block diagram showing the structure of a vehicle projection control system according to a second embodiment.

FIG. 15 is a block diagram showing the structure of a vehicle projection control system according to the second embodiment.

FIG. 16 is a block diagram showing the structure of a vehicle projection control system according to the second embodiment.

FIG. 17 explains the operation of a vehicle projection control device according to a third embodiment.

FIG. 18 explains the operation of the vehicle projection control device according to the fourth embodiment.

FIG. 19 explains the operation of the vehicle projection control device according to the fourth embodiment.

FIG. 20 explains the operation of the vehicle projection control device according to the fourth embodiment.

FIG. 21 explains the operation of the vehicle projection control device according to the fourth embodiment.

FIG. 22 explains the operation of the vehicle projection control device according to the fourth embodiment.

FIG. 23 explains the operation of the vehicle projection control device according to the fourth embodiment.

FIG. 24 explains a modification of the operation of the vehicle projection control device according to the fourth embodiment.

FIG. 25 is a block diagram showing the structure of a vehicle projection control system according to a fifth embodiment.

FIG. 26 explains the operation of a vehicle projection control device according to the fifth embodiment.

FIG. 27 explains the operation of the vehicle projection control device according to the fifth embodiment.

FIG. 28 is a block diagram showing the structure of a vehicle projection control system according to a sixth embodiment.

FIG. 29 explains the operation of a vehicle projection control device according to the sixth embodiment.

FIG. 30 explains the operation of the vehicle projection control device according to the sixth embodiment.

FIG. 31 explains the operation of the vehicle projection control device according to the sixth embodiment.

FIG. 32 is a block diagram showing the structure of a vehicle projection control system according to a seventh embodiment.

FIG. 33 explains the operation of a vehicle projection control device according to the seventh embodiment.

FIG. 34 is a block diagram showing the structure of a vehicle projection control system according to an eighth embodiment.

FIG. 35 explains the operation of a vehicle projection control device according to the eighth embodiment.

FIG. 36 is a block diagram showing the structure of a vehicle projection control system according to a ninth embodiment.

FIG. 37 is a block diagram showing the structure of a vehicle projection control system according to a tenth embodiment.

FIG. 38 explains the operation of a vehicle projection control device according to an eleventh embodiment.

FIG. 39 explains the operation of the vehicle projection control device according to the eleventh embodiment.

FIG. 40 explains the operation of the vehicle projection control device according to the eleventh embodiment.

FIG. 41 explains the operation of the vehicle projection control device according to the eleventh embodiment.

FIG. 42 explains the operation of the vehicle projection control device according to the eleventh embodiment.

FIG. 43 is a block diagram showing the structure of a vehicle projection control system according to a twelfth embodiment.

FIG. 44 explains the operation of a vehicle projection control device according to the twelfth embodiment.

FIG. 45 explains the operation of the vehicle projection control device according to the twelfth embodiment.

FIG. 46 explains the operation of the vehicle projection control device according to the twelfth embodiment.

FIG. 47 explains the operation of the vehicle projection control device according to the twelfth embodiment.

FIG. 48 is a flowchart showing the operation of the vehicle projection control device according to the twelfth embodiment.

FIG. 49 is a block diagram showing the structure of a vehicle projection control system according to a thirteenth embodiment.

FIG. 50 explains a precedence relationship between roads.

FIG. 51 explains a precedence relationship between roads.

FIG. 52 shows an example of a projection pattern of light projected from a vehicle in the thirteenth embodiment.

FIG. 53 explains the operation of a vehicle projection control device according to the thirteenth embodiment.

FIG. 54 explains the operation of the vehicle projection control device according to the thirteenth embodiment.

FIG. 55 explains the operation of the vehicle projection control device according to the thirteenth embodiment.

FIG. 56 is a flowchart showing the operation of the vehicle projection control device according to the thirteenth embodiment.

FIG. 57 is a flowchart showing a projection pattern deciding process.

FIG. 58 explains a modification of the projection pattern deciding process.

FIG. 59 is a flowchart showing the modification of the projection pattern deciding process.

FIG. 60 shows an example of a graphic object indicating time to elapse before an own vehicle reaches a connection point.

FIG. 61 shows an example of a graphic object indicating time to elapse before an own vehicle reaches a connection point.

FIG. 62 shows an example of a graphic object indicating time to elapse before an own vehicle reaches a connection point.

FIG. 63 shows an example of a graphic object indicating time to elapse before an own vehicle reaches a connection point.

FIG. 64 shows an example of a graphic object indicating time to elapse before an own vehicle reaches a connection point.

FIG. 65 shows an example of a graphic object indicating time to elapse before an own vehicle reaches a connection point.

FIG. 66 shows an example of a graphic object indicating time to elapse before an own vehicle reaches a connection point.

FIG. 67 shows an example of a graphic object indicating time to elapse before an own vehicle reaches a connection point.

FIG. 68 shows an example of a graphic object indicating time to elapse before an own vehicle reaches a connection point.

FIG. 69 shows an example of a graphic object indicating time to elapse before an own vehicle reaches a connection point.

FIG. 70 shows an example of a graphic object indicating time to elapse before an own vehicle reaches a connection point.

FIG. 71 shows an example of a graphic object indicating time to elapse before an own vehicle reaches a connection point.

### DESCRIPTION OF EMBODIMENTS

### First Embodiment

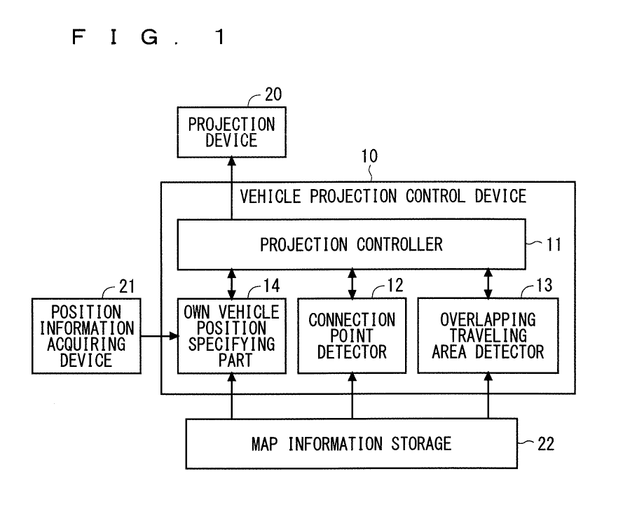

FIG. 1 is a block diagram showing the structure of a vehicle projection control system according to a first embodiment. As shown in FIG. 1, the vehicle projection control system includes a vehicle projection control device 10, a projection device 20, a position information acquiring device 21, and a map information storage 22. The projection device 20, the position information acquiring device 21, and the map information storage 22 show structures external to the vehicle projection control device 10. However, the projection device 20, the position information acquiring device 21, and the map information storage 22 may be formed as structures integral with the vehicle projection control device 10.

The projection device 20 is installed on a vehicle and can project an image to a surrounding of this vehicle. Specific examples of the projection device 20 may include a laser, an LED (light emitting diode) light projection device, and a projector. The projection device 20 may use a headlight of a vehicle as a light source.

The position information acquiring device 21 acquires a current position of a vehicle on which the vehicle projection control device 10 is installed. A specific representative example of the position information acquiring device 21 is a GNSS (global navigation satellite system) receiver that receives a signal from a GNSS such as a GPS (global positioning system) to acquire information about an absolute position (in terms of a latitude or a longitude). The position information acquiring device 21 may also include a speed sensor or a direction sensor for acquiring information about a relative position (position change).

The map information storage 22 is a storage medium such as a hard disk or a removal medium storing map information. The map information stored in the map information storage 22 contains characteristic information about each road and characteristic information about each connection point between roads. The characteristic information about a road includes a road width, the number of lanes, and regulation on a traveling direction (one way), for example. The characteristic information about each connection point between roads includes regulation on a traveling direction (prohibition of traveling in a direction except a designated direction (right-turn prohibition or left-turn prohibition, etc.)), a precedence relationship between roads, and a connection angle between roads, for example. The map information storage 22 may be a server that provides the vehicle projection control device 10 with the map information via a communication network such as the Internet.

The vehicle projection control device 10 is a control device that controls the operation of the projection device 20. The vehicle projection control device 10 includes a projection controller 11, a connection point detector 12, an overlapping traveling area detector 13, and an own vehicle position specifying part 14. The vehicle projection control device 10 is configured by using a computer. The projection controller 11, the connection point detector 12, the overlapping traveling area detector 13, and the own vehicle position specifying part 14 are realized by the operation of the computer according to a program. In the below, a vehicle on which the vehicle projection control device 10 and the projection device 20 are installed is called an “own vehicle,” and vehicles other than the own vehicle is called “other vehicles.”

The projection controller 11 can control the operation of the projection device 20 and project an image to a surrounding of an own vehicle by using the projection device 20. The projection controller 11 determines a direction in which the projection device 20 projects an image (the position of the displayed image) and the orientation of the projected image (the posture of the displayed image).

The connection point detector 12 detects a connection point (such as an intersection or a turning point) between a road on which an own vehicle is traveling and another road connected to this road. In the below, a road on which an own vehicle is traveling is called an “own vehicle traveling road,” and a road connected to the own vehicle traveling road is called a “connected road.” The overlapping traveling area detector 13 divides a connection point into a plurality of areas and detects one or more areas of these areas that permits traveling of both another vehicle to enter the connection point from a connected road and an own vehicle. In the below, an area at a connection point that permits traveling of both another vehicle to enter the connection point from a connected road and an own vehicle is called an “overlapping traveling area.”

The own vehicle position specifying part 14 performs a map matching process using information about a current position of an own vehicle acquired by the position information acquiring device 21 and the map information stored in the map information storage 22 to specify the position of the own vehicle on a map. An own vehicle traveling road is specified by finding the position of the own vehicle.

In the first embodiment, the connection point detector 12 detects a connection point between an own vehicle traveling road and a connected road based on the map information stored in the map information storage 22 and the position of an own vehicle on a map specified by the own vehicle position specifying part 14. The overlapping traveling area detector 13 detects an overlapping traveling area at the connection point detected by the connection point detector 12 based on the characteristic information about each road and the characteristic information about each connection point (particularly, information about regulation on a traveling direction) contained in the map information.

The projection controller 11 of the vehicle projection control device 10 uses the projection device 20 to project an image to a connection point existing ahead of an own vehicle in a traveling direction and being one of connection points detected by the connection point detector 12 (in this case, the connection point detector 12 may detect only a connection point existing ahead of the own vehicle in the traveling direction). At this time, the projection controller 11 makes the projection device 20 project an image toward an overlapping traveling area at the connection point detected by the overlapping traveling area detector 13.

The projection controller 11 decides the content of an image to be projected by using the projection device 20. Further, for projection of the image to an overlapping traveling area at a connection point, the projection controller 11 decides the orientation of the image in a manner that depends on the direction of a connected road connected to this connection point. The image to be projected to the overlapping traveling area at the connection point by the projection controller 11 by using the projection device 20 (projected image) may include various types of images. In the first embodiment, the projected image is formed of a word “CAUTION.”

Next, the operation of the vehicle projection control device 10 according to the first embodiment is descried in detail. In the vehicle projection control device 10, if the connection point detector 12 detects the existence of a connection point ahead of an own vehicle in a traveling direction between an own vehicle traveling road and a connected road, the overlapping traveling area detector 13 searches for an overlapping traveling area in this connection point. If the overlapping traveling area detector 13 detects an overlapping traveling area, the projection controller 11 projects an image (word “CAUTION”) to the overlapping traveling area.

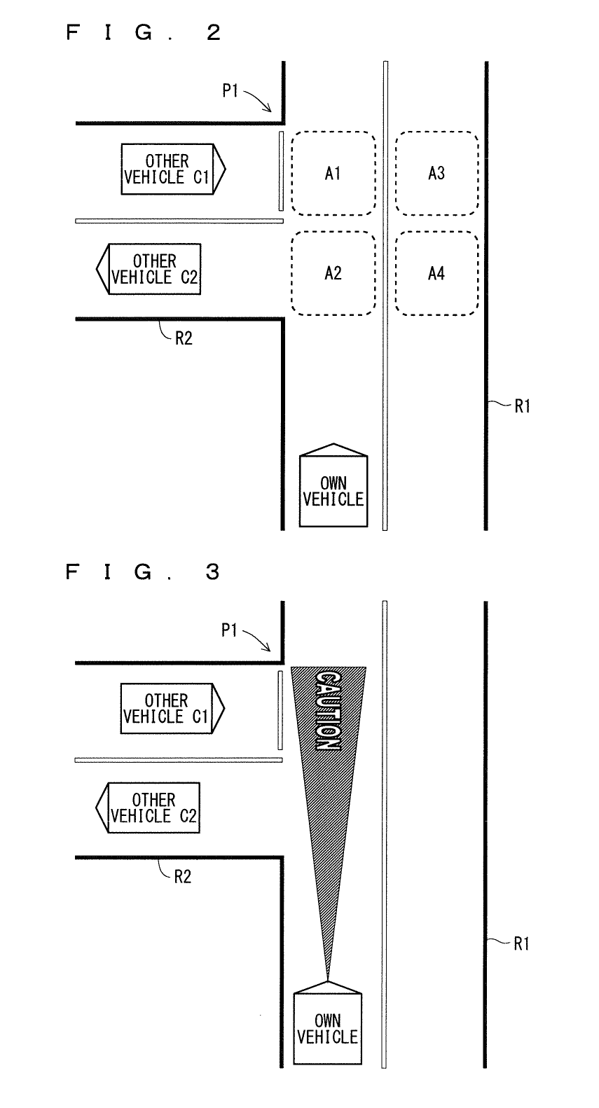

It is assumed, for example, that there is a connection point P1 where a connected road R2 is connected to the left side of an own vehicle traveling road R1, as shown in FIG. 2. In this example, both the own vehicle traveling road R1 and the connected road R2 are left-hand two-lane (one-lane each way) roads. For the convenience of description, another vehicle C1 and another vehicle C2 traveling on the connected road R2 are shown in FIG. 2. Meanwhile, the vehicle projection control device 10 according to the first embodiment does not detect another vehicle, so that the operation of the vehicle projection control device 10 is not affected by the presence or absence of another vehicle.

In the vehicle projection control device 10, if the connection point detector 12 detects the connection point P1 existing ahead of the own vehicle in a traveling direction, the overlapping traveling area detector 13 searches for an overlapping traveling area in the connection point P1. More specifically, the overlapping traveling area detector 13 divides the connection point P1 into two-by-two areas A1 to A4 shown in FIG. 2 and determines whether or hot each of these areas is an overlapping traveling area based on the characteristic information about each road and the characteristic information about each connection point contained in the map information.

Referring to FIG. 2, the own vehicle can go straight ahead or turn left at the connection point P1. The other vehicle C1 can turn left or turn right at the connection point P1. The other vehicle C2 is traveling in a direction away from the connection point P1. The own vehicle is to pass through the areas A1 and A2 for going straight ahead and to pass through the area A2 for turning left. Thus, an area that permits traveling of the own vehicle at the connection point P1 includes the areas A1 and A2. The other vehicle C1 to enter the connection point P1 from the connected road R2 is to pass through the area A1 for turning left and to pass through the areas A1, A3, and A4 for turning right. Thus, the areas A1, A3, A4 can be determined to be areas that permit traveling of the other vehicle C1. The other vehicle C2 does not have an area at the connection point P1 that permits traveling of the other vehicle C2. Thus, regarding the connection point P1 shown in FIG. 2, the overlapping traveling area detector 13 detects the area A1 as an overlapping traveling area overlapping between the areas A1 and A2 that permit traveling of the own vehicle and the areas A1 and A3 that permit traveling of the other vehicle C1.

In this case, as shown in FIG. 3, the projection controller 11 projects an image (word “CAUTION”) to the overlapping traveling area A1 by using the projection device 20. At this time, in order for the other vehicle C1 to enter the overlapping traveling area A1 to recognize the image easily, the projection controller 11 adjusts the orientation of the image. In this example, the connected road R2 is connected to the left side of the own vehicle traveling road R1. Thus, the projection controller 11 places the word “CAUTION” in an orientation in which the word “CAUTION” is viewed in a correct posture from the left side (this orientation is defined as a “left-pointing orientation”).

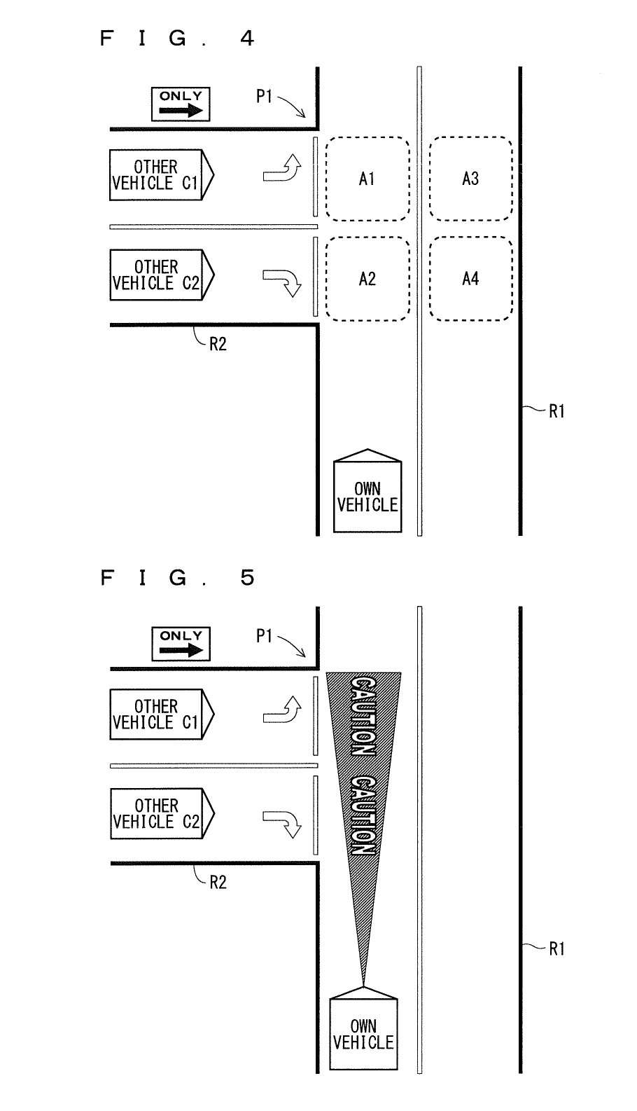

It is assumed that the connected road R2 connected to the left side of the own vehicle traveling road R1 is a two-lane road on which one-way traffic in a direction toward the connection point P1 is defined, as shown in FIG. 4. In this case, an own vehicle is only permitted to go straight ahead at the connection point P1, another vehicle C1 is only permitted to turn left at the connection point P1, and another vehicle C2 is only permitted to turn right at the connection point P1. Thus, an area that permits traveling of the own vehicle at the connection point P1 includes the areas A1 and A2. Further, the area A1 can be determined to be an area that permits traveling of the other vehicle C1. The areas A2 and A4 can be determined to be areas that permit traveling of the other vehicle C2. Thus, regarding the connection point P1 shown in FIG. 4, the overlapping traveling area detector 13 detects the areas A1 and A2 as overlapping traveling areas overlapping between the areas A1 and A2 that permit traveling of the own vehicle and the areas A1, A2, and A4 that permit traveling of the other vehicles C1 and C2.

In this case, as shown in FIG. 5, the projection controller 11 projects a word “CAUTION” to each of the overlapping traveling areas A1 and A2 by using the projection device 20. The connected road R2 is connected to the left side of the own vehicle traveling road R1. Thus, the projection controller 11 places the two words “CAUTION” and “CAUTION” in their left-pointing orientations.

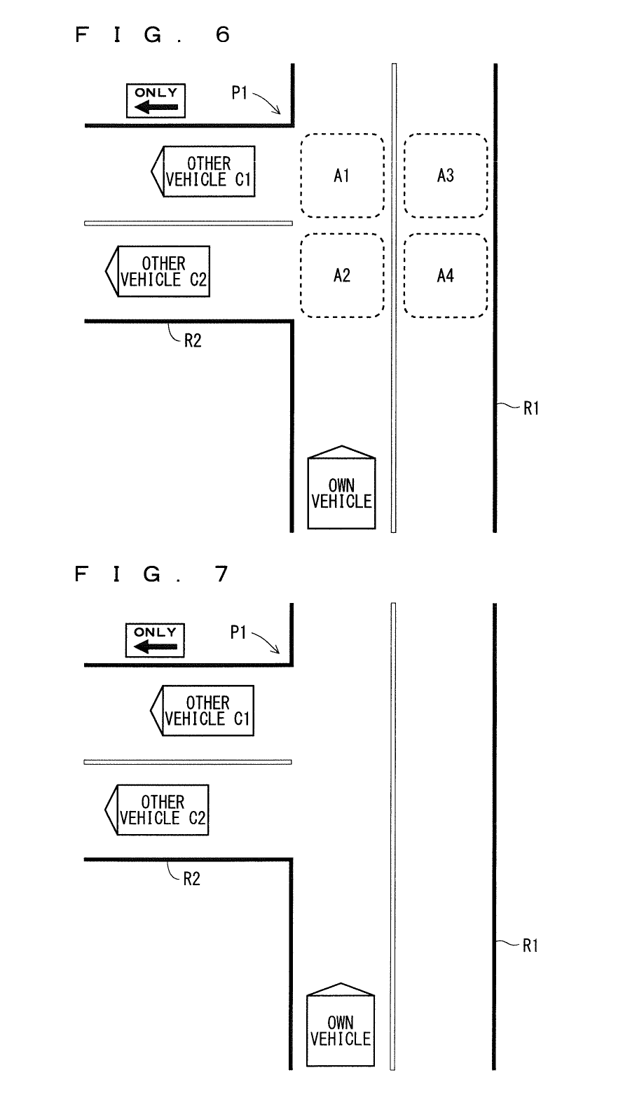

It is assumed that the connected road R2 connected to the left side of the own vehicle traveling road R1 is a two-lane road on which one-way traffic in a direction away from the connection point P1 is defined, as shown in FIG. 6. In this case, an own vehicle is permitted to go straight ahead, turn left at the connection point P1, and travel in the areas A1 and A2. Meanwhile, another vehicle C1 and another vehicle C2 on the connected road R2 are to travel in directions away from the connection point P1. Hence, the other vehicles C1 and C2 do not have an area at the connection point P1 that permits traveling of the other vehicles C1 and C2. Thus, regarding the connection point P1 shown in FIG. 6, the overlapping traveling area detector 13 determines that there is no overlapping traveling area. In this case, as shown in FIG. 7, the projection controller 11 does not project an image to the connection point P1.

The illustration of FIG. 7 shows that no light is to be projected. Alternatively, light containing no image may be projected to the connection point P1 (to the areas A1 and A1 that permit traveling of an own vehicle, for example). In the illustration of FIG. 7, a pedestrian free from one-way restriction may enter the connection point P1 from the connected road R2. In this case, by projecting light containing no image from an own vehicle, the pedestrian can be urged to be cautious by being notified of the approach of the own vehicle toward the connection point P1.

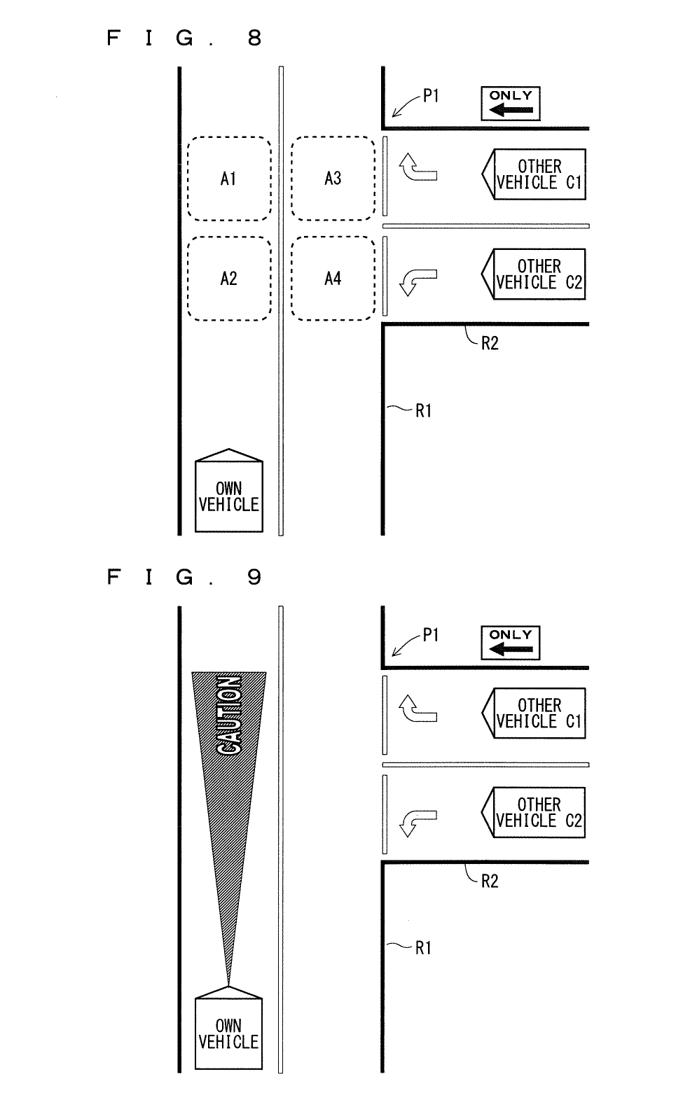

It is assumed that the connected road R2, which is a two-lane road on which one-way traffic in a direction toward the connection point P1 is defined, is connected to the right side of the own vehicle traveling road R1, as shown in FIG. 8. In this case, an own vehicle is only permitted to go straight ahead at the connection point P1, another vehicle C1 is only permitted to turn right at the connection point P1, and another vehicle C2 is only permitted to turn left at the connection point P1. Thus, an area that permits traveling of the own vehicle at the connection point P1 includes the areas A1 and A2. Further, the areas A1 and A3 can be determined to be areas that permit traveling of the other vehicle C1. The area A4 can be determined to be an area that permits traveling of the other vehicle C2. Thus, regarding the connection point P1 shown in FIG. 8, the overlapping traveling area detector 13 detects the area A1 as an overlapping traveling area overlapping between the areas A1 and A2 that permit traveling of the own vehicle and the areas A1, A3, and A4 that permit traveling of the other vehicles C1 and C2.

In this case, as shown in FIG. 9, the projection controller 11 projects a word “CAUTION” to the overlapping traveling area A1 by using the projection device 20. The connected road R2 is connected to the right side of the own vehicle traveling road R1. Thus, the projection controller 11 places the word “CAUTION” in a right-pointing orientation.

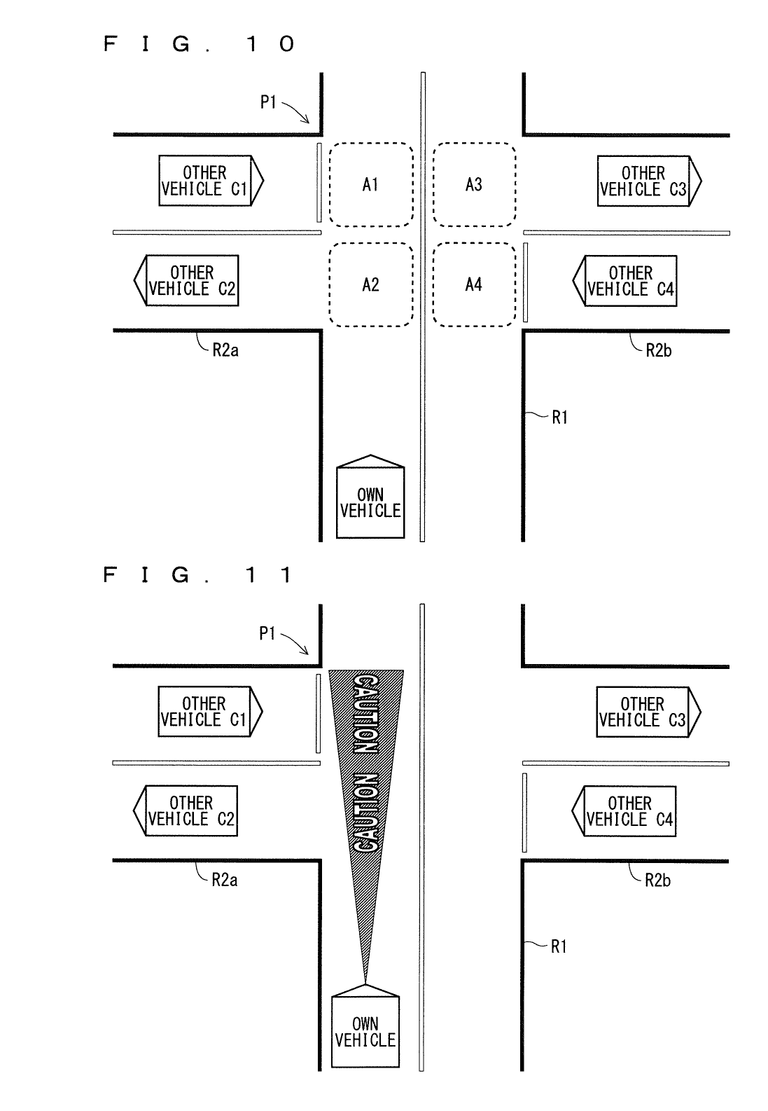

It is further assumed that, at the same connection point P1, a connected road R2a is connected to the left side of the own vehicle traveling road R1 and a connected road R2b is connected to the right side of the own vehicle traveling road R1 (specifically, the connection point P1 is an intersection (crossroads)), as shown in FIG. 10. In this example, each of the own vehicle traveling road R1 and the connected roads R2a and R2b is assumed to be a left-hand two-lane (one-lane each way) road.

In this case, an own vehicle is permitted to go straight ahead, turn right, and turn left at the connection point P1. Thus, an area that permits traveling of the own vehicle includes the areas A1, A2, and A3. Another vehicle C1 to enter the connection point P1 from the connected road R2a is also permitted to go straight ahead, turn right, and turn left at the connection point P1. Thus, the areas A1, A3, and A4 can be determined to be areas that permit traveling of the other vehicle C1. Another vehicle C4 to enter the connection point P1 from the connected road R2b is also permitted to go straight ahead, turn right, and turn left at the connection point P1. Thus, the areas A1, A2, and A4 can be determined to be areas that permit traveling of the other vehicle C4. Another vehicle C2 and another vehicle C3 traveling in directions away from the connection point P1 do not have an area at the connection point P1 that permits traveling of the other vehicles C2 and C3. Thus, regarding the connection point P1 shown in FIG. 10, the overlapping traveling area detector 13 detects the areas A1, A2, A3 as overlapping traveling areas overlapping between the areas A1, A2, and A3 that permit traveling of the own vehicle and the areas A1 to A4 that permit traveling of the other vehicles C1 and C4.

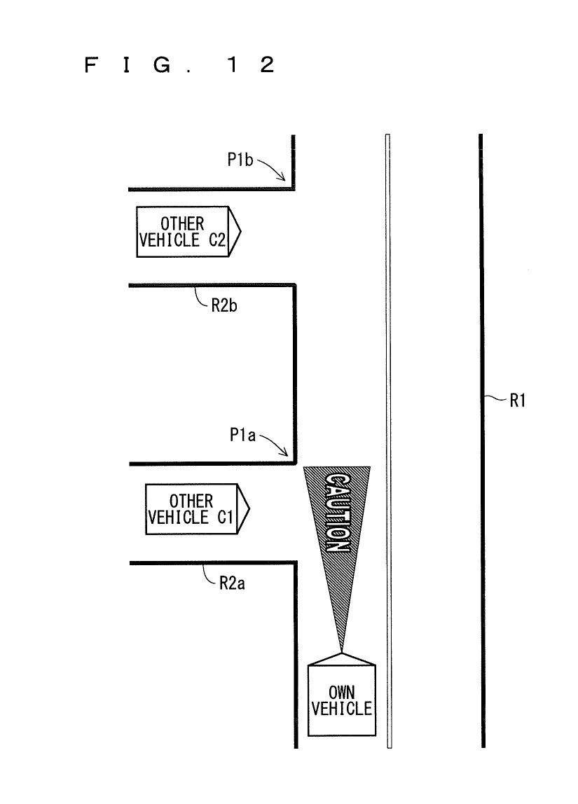

In this case, a word “CAUTION” may be projected to each of the overlapping traveling areas A1, A2, and A3. Meanwhile, in this embodiment, to avoid interference with traveling of a vehicle in a lane opposite to the own vehicle, an image is not to be projected to the area A3 in the opposite lane. Thus, as shown in FIG. 11, the projection controller 11 projects a word “CAUTION” to each of the overlapping traveling areas A1 and A2 by using the projection device 20. In embodiments described below, in principle, an image is also not to be projected to an opposite lane by the projection controller 11.

The word “CAUTION” projected to the overlapping traveling area A1 is placed in a left-pointing orientation so as to be recognized easily by the other vehicle C1 on the connected road R2a. The word “CAUTION” projected to the overlapping traveling area A2 is placed in a right-pointing orientation (orientation in which the word “CAUTION” is viewed in a correct posture from the right side) so as to be recognized easily by the other vehicle C4 on the connected road R2b.

In the first embodiment, for detection of a connection point, the connection point detector 12 is to calculate a distance from an own vehicle to the connection point. The projection controller 11 is to project an image only to an overlapping traveling area at a connection point existing in a predetermined range ahead of the own vehicle in a traveling direction. Specifically, as shown in FIG. 12, even if there are two connection points P1a and P1b existing ahead of an own vehicle in a traveling direction, the vehicle projection control device 10 does not project an image to an overlapping traveling area at the connection point P1b far from the own vehicle.

A threshold for a distance used as a criterion for determination as to whether or not an image is to be projected to a connection point may be changed in a manner that depends on the speed of an own vehicle. If the speed of the own vehicle is high, for example, the own vehicle will reach the connection point in a short time. Thus, it is desirable that projection of an image be started earlier than usual (specifically, it is desirable that an image be projected also to a connection point far from the own vehicle).

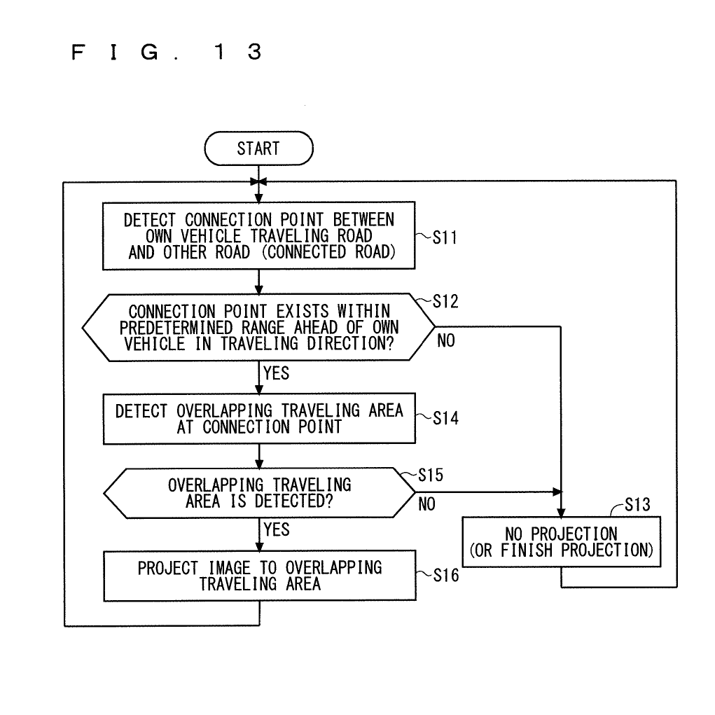

FIG. 13 is a flowchart showing the operation of the vehicle projection control device 10 according to the first embodiment. The operations described by referring to FIGS. 2 and 12 are realized by implementation of processes shown in FIG. 13 by the vehicle projection control device 10. The processes of FIG. 13 are finished in response to an action for finishing these processes taken by a user on the vehicle projection control device 10, input of a command given from a different device instructing finish of these processes to the vehicle projection control device 10, or receipt of a command instructing finish of these processes given from a different process performed by the vehicle projection control device 10, for example.

When the vehicle projection control device 10 is started, the own vehicle position specifying part 14 first specifies the position of an own vehicle on a map. Based on a result of the specification, the connection point detector 12 detects a connection point between an own vehicle traveling road and another road (connected road) (step S11). Further, the connection point detector 12 calculates a distance from the own vehicle to the connection point and determines whether or not the connection point exists within a predetermined range ahead of the own vehicle in a traveling direction (step S12).

If the connection point does not exist within the predetermined range ahead of the own vehicle in the traveling direction (step S12: NO), an image is not projected to an overlapping traveling area by using the projection device 20 (step S13). Then, the flow returns to step S11. In step S13, if an image has already been projected to the overlapping traveling area, this projection is finished.

If the connection point exists within the predetermined range ahead of the own vehicle in the traveling direction (step S12: YES), this connection point becomes a target of image projection. In this case, the overlapping traveling area detector 13 detects an overlapping traveling area at this connection point (step S14). If an overlapping traveling area is not detected (step S15: NO), the flow shifts to step S13 described above and then returns to step S11 without projecting an image.

If the overlapping traveling area detector 13 detects an overlapping traveling area (step S15: YES), the projection controller 11 controls the projection device 20 to project an image toward the detected overlapping traveling area (step S16). The orientation of the image projected at this time is adjusted in a manner that depends on a side on which the connected road is connected to the own vehicle traveling road. Then, the flow returns to step S11. Specifically, the processes from steps S11 to S16 are performed repeatedly.

An overlapping traveling area detected by the overlapping traveling area detector 13 is an area at a connection area that permits traveling of both an own vehicle and another vehicle to enter the connection point from a connected road. Thus, this overlapping traveling area is also an area in which collision of the own vehicle with the other vehicle is probable, so that it is to watch out for particularly. In the vehicle projection control system according to the first embodiment, an image is projected to an area that permits traveling of a vehicle. This allows a driver of the own vehicle and a driver of the other vehicle to recognize the overlapping traveling area easily based on the position of the projected image.

In the example shown in FIG. 2, etc., the overlapping traveling area detector 13 divides one connection point into two-by-two areas. A method of dividing a connection point or the number of divisions can be changed in a manner that depends on the number of lanes and the road width of an own vehicle traveling road and those of a connected road. Each area may have a portion overlapping a portion of a different area.

### Second Embodiment

In the first embodiment, the connection point detector 12 detects a connection point based on the map information and the position of an own vehicle on a map, and the overlapping traveling area detector 13 detects an overlapping traveling area based on the map information (particularly, information about regulation on a traveling direction). However, each of the process of detecting a connection point by the connection point detector 12 and the process of detecting an overlapping traveling area by the overlapping traveling area detector 13 can be performed in a different way. Several examples of such a different way are described herein.

For example, if an infrastructure such as a beacon to distribute traffic information is developed and a distribution facility to distribute position information about a connection point (this may be relative position information indicating a distance from a current position, for example) and information about an overlapping traveling area at this connection point is installed at every place of a road network, each of the process by the connection point detector 12 and the process by the overlapping traveling area detector 13 may be performed based on information acquired as a result of communication with each distribution facility.

FIG. 14 is a block diagram showing the structure of a vehicle projection control system employed in such a case. The vehicle projection control device 10 is connected to a communication device 23 that makes communication with an information distribution facility. The communication device 23 may be provided inside the vehicle projection control device 10.

The vehicle projection control device 10 makes communication by using the communication device 23 to acquire position information about a connection point and position information about an overlapping traveling area in this connection point from the information distribution facility. The connection point detector 12 detects the position of the connection point ahead of an own vehicle in a traveling direction based on the position information about the connection point acquired by the communication device 23 from the distribution facility. The overlapping traveling area detector 13 detects the overlapping traveling area based on the position information about the overlapping traveling area acquired by the communication device 23 from the distribution facility. The other processes can be the same as those in the first embodiment.

As another example, the connection point detector 12 may detect a connection point or the overlapping traveling area detector 13 may detect an overlapping traveling area based on an image of a surrounding of an own vehicle taken by a camera installed on the own vehicle (on-board camera) or information acquired by various sensors (on-board sensors) installed on the own vehicle.

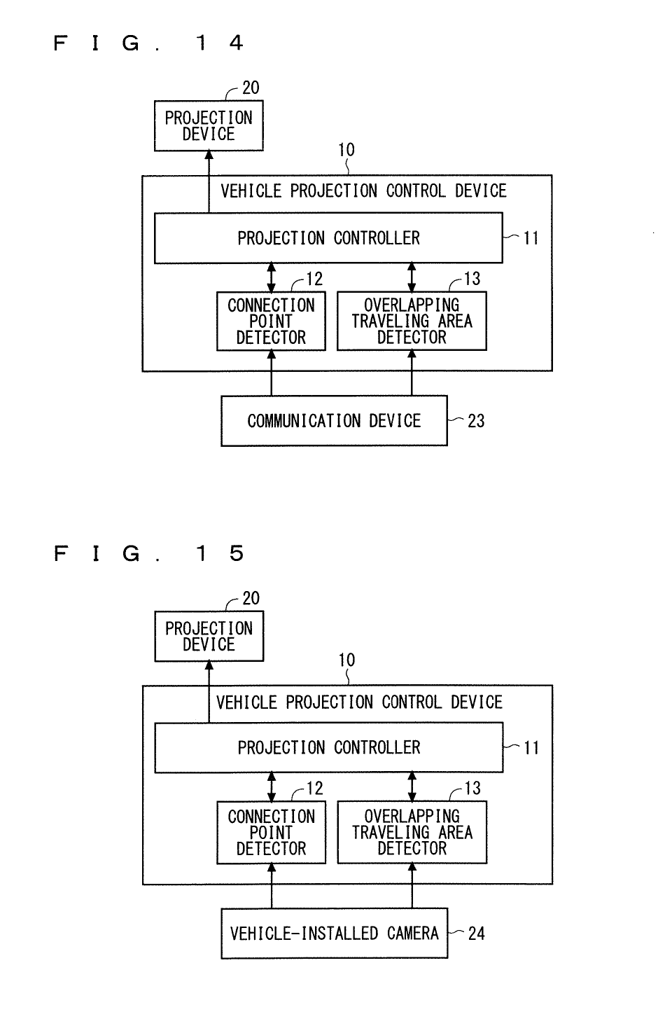

FIG. 15 is a block diagram showing the structure of a vehicle projection control system employed in the use of an on-board camera 24 (the on-board camera 24 may be provided inside the vehicle projection control device 10). In this structure, the vehicle projection control device 10 captures an image of a place ahead of an own vehicle in a traveling direction by using the on-board camera 24 and performs an analyzing process on the captured image.

Processes performed as this image analyzing process include extraction of a connection point, calculation of a distance to the connection point, extraction of a road sign (including a road marking such as a stop line), extraction of the contour or the center line of an own vehicle traveling road and that of a connected road, and estimation of the width of the own vehicle traveling road and that of the connected road, for example. The connection point detector 12 detects the position of the connection point ahead of the own vehicle in a traveling direction based on a result of the image analysis. The overlapping traveling area detector 13 detects an overlapping traveling area in this connection point based on the result of the image analysis. The other processes can be the same as those in the first embodiment.

FIG. 16 is a block diagram showing the structure of a vehicle projection control system employed in the use of an on-board sensor 25 (the on-board sensor 25 may be provided inside the vehicle projection control device 10). In this structure, the vehicle projection control device 10 analyzes sensor information acquired from the on-board sensor 25 (such as a distance sensor or a radar used for detecting an object in a surrounding of an own vehicle, for example) to determine the presence or absence of a connection point, a distance to the connection point, the type of a road sign, the contour or the position of the center line of an own vehicle traveling road and that of a connected road, and the width of the own vehicle traveling road and that of the connected road, for example. The connection point detector 12 detects the position of the connection point ahead of the own vehicle in a traveling direction based on a result of the analysis on the sensor information. The overlapping traveling area detector 13 detects an overlapping traveling area in this connection point based on the result of the analysis on the sensor information. The other processes can be the same as those in the first embodiment.

The technique of using the communication device 23, the on-board camera 24, or the on-board sensor 25 may be employed in combination with the technique of using the position information acquiring device 21 and the map information storage 22 according to the first embodiment. For example, the technique of using the communication device 23 may be employed in a region where an information distribution facility is developed or in a place where a signal from a GNSS cannot be received. The technique of using the position information acquiring device 21 and the map information storage 22 may be employed in other regions. Additionally, a result of the map matching process performed by the own vehicle position specifying part 14 may be corrected based on a result of analysis on an image captured by the on-board camera 24 or on sensor information acquired by the on-board sensor 25. By doing so, the accuracy of the position of an own vehicle can be enhanced.

### Third Embodiment

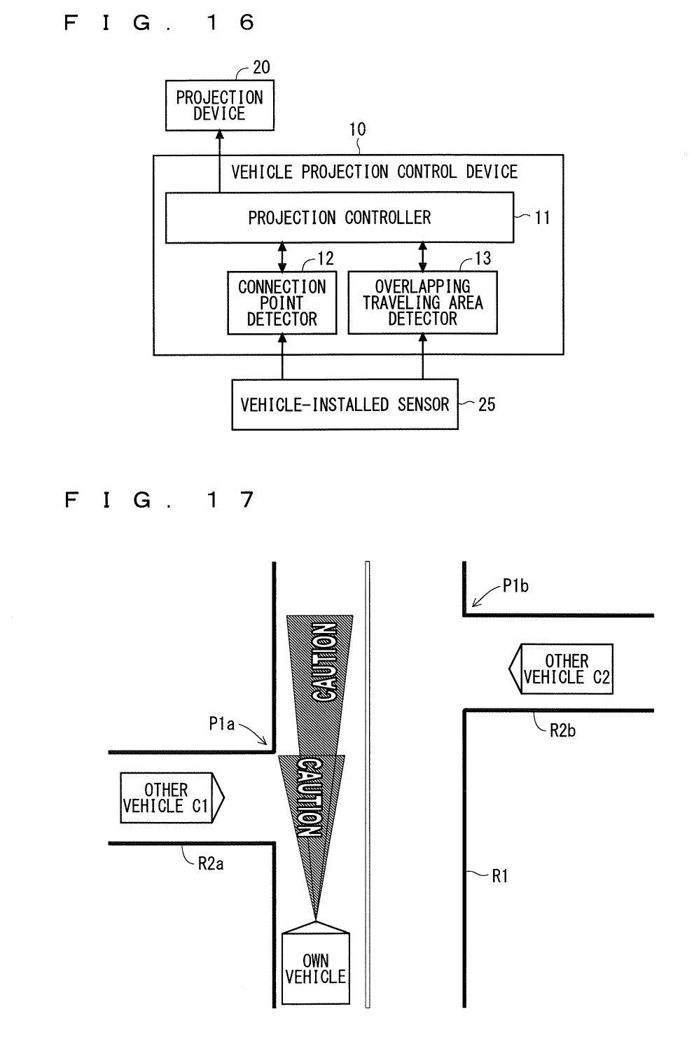

There may be a plurality of projection devices 20 to be controlled by the vehicle projection control device 10. In this case, as shown in FIG. 17, if two connection points P1a and P1b are determined to exist in a predetermined range ahead of an own vehicle in a traveling direction as a result of simultaneous detection of a plurality of connection points by the connection point detector 12, for example, an image can be projected to an overlapping traveling area existing at each of the connection points P1a and P1b.

At this time, the orientation of the image to be projected to the overlapping traveling area at the connection point P1a is decided in a manner that depends on the direction of a connected road R2a connected to an own vehicle traveling road R1 at the connection point P1a. The orientation of the image to be projected to the overlapping traveling area at the connection point P1b is decided in a manner that depends on the direction of a connected road R2b connected to the own vehicle traveling road R1 at the connection point P1b. In the illustration of FIG. 17, an image (word “CAUTION”) in a left-pointing orientation is projected to the overlapping traveling area at the connection point P1a where the connected road R2a is connected to the left side of the own vehicle traveling road R1. Further, an image in a right-pointing orientation is projected to the overlapping traveling area at the connection point P1b where the connected road R2b is connected to the right side of the own vehicle traveling road R1.

### Fourth Embodiment

In the example described in the first embodiment, an image (projected image) to be projected to an overlapping traveling area at a connection point by the vehicle projection control device 10 by using the projection device 20 is a word “CAUTION.” However, this word is not the only example of the projected image.

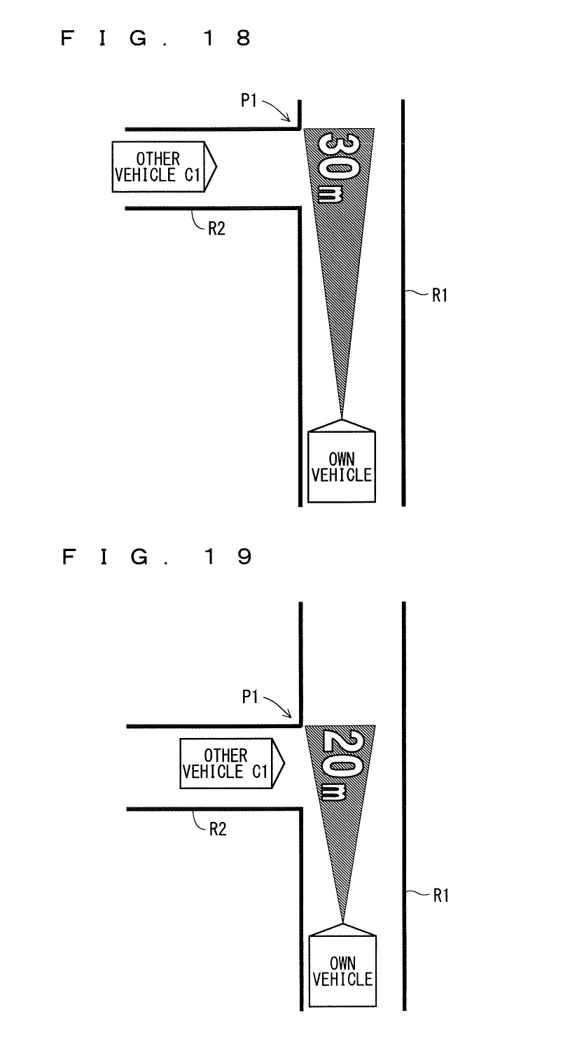

An image to change in a manner that depends on the position or the speed of an own vehicle may be used. For example, a character indicating a distance from the own vehicle to a connection point may be projected to an overlapping traveling area at this connection point ahead of the own vehicle in a traveling direction. FIGS. 18 and 19 show change in a projected image occurring in this case. As shown in FIG. 18, if the own vehicle is at 30 m before a connection point P1, characters “30 m” are projected to an overlapping traveling area at the connection point P1. As shown in FIG. 19, if the own vehicle is at 20 m before the connection point P1, characters “20 m” are projected to this overlapping traveling area.

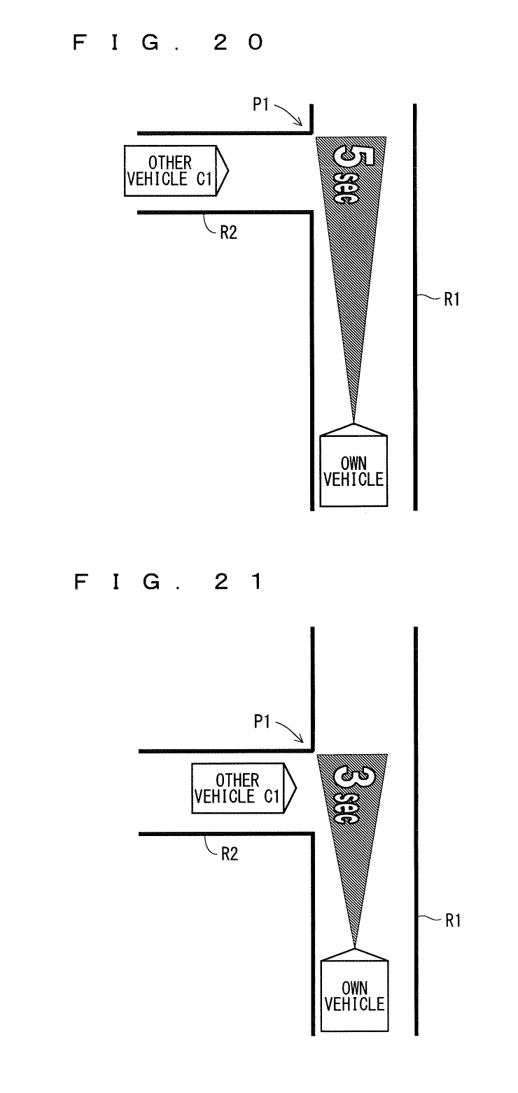

Alternatively, time to elapse before an own vehicle reaches a connection point ahead of an own vehicle in a traveling direction may be projected to an overlapping traveling area at this connection point. FIGS. 20 and 21 show change in a projected image occurring in this case. As shown in FIG. 20, at five seconds before the own vehicle reaches the connection point P1, characters “5 sec” are projected to an overlapping traveling area at the connection point P1. As shown in FIG. 21, at three seconds before the own vehicle reaches the connection point P1, characters “3 sec” are projected to this overlapping traveling area.

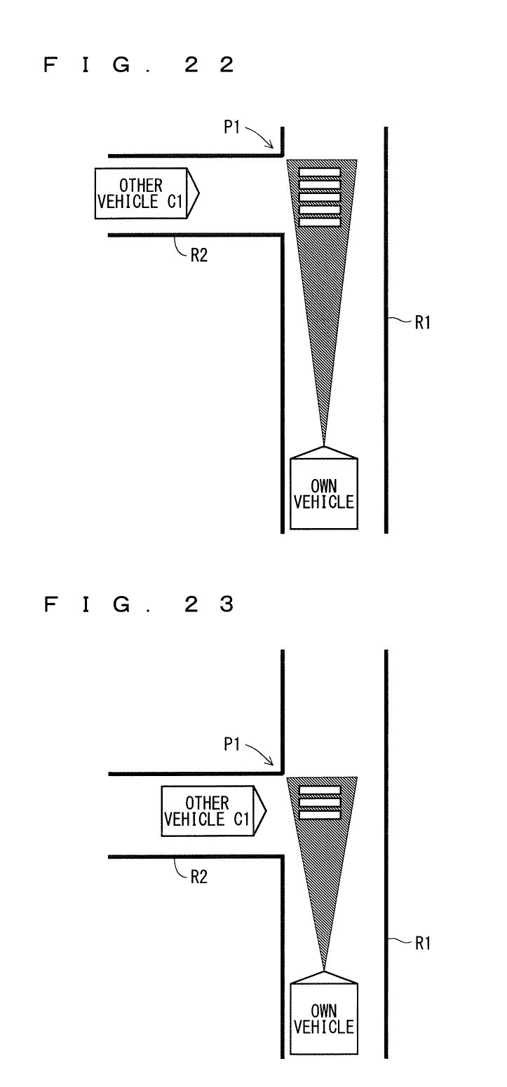

A graphic object indicating a distance from an own vehicle to a connection point ahead of the own vehicle in a traveling direction or time to elapse before the own vehicle reaches the connection point may be projected to an overlapping traveling area at this connection point. FIGS. 22 and 23 show change in a projected image occurring in this case. As shown in FIG. 22, at five seconds before the own vehicle reaches the connection point P1, five rectangles are projected to an overlapping traveling area at the connection point P1. As shown in FIG. 23, at three seconds before the own vehicle reaches the connection point P1, three rectangles are projected to this overlapping traveling area.

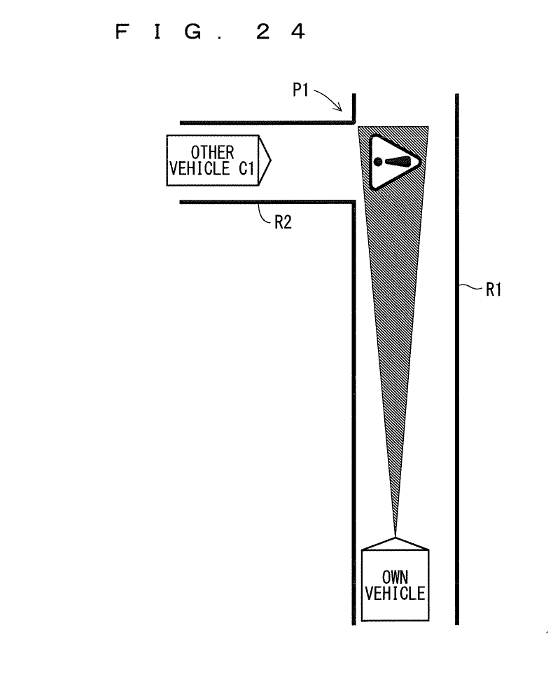

An image showing a distance from an own vehicle to a connection point or time to elapse before the own vehicle reaches the connection point may be displayed in a style to be changed in a manner that depends on a distance from the own vehicle to the connection point or time to elapse before the own vehicle reaches the connection point. For example, if the own vehicle is in a position far from the connection point P1, it is hard to project a character clearly to the connection point P1. This can be handled by projecting a symbol (here, “!”) not requiring visibility as high as that for a character, as shown in FIG. 24. When the own vehicle comes to some degree of proximity to the connection point P1, a character or a graphic object may be projected to the connection point P1, as shown in FIGS. 18 to 23.

An image showing a distance from an own vehicle to a connection point or time to elapse before the own vehicle reaches the connection point may be a code (such as a two-dimensional bar code) readable by an electronic device, etc. For example, by making a code reader on another vehicle read a code projected to a connection point from an own vehicle, the position of the own vehicle can be recognized by a device installed on the other vehicle and can be used for traveling control of the other vehicle.

An image to be projected to an overlapping traveling area may be an image showing a distance from an own vehicle to the overlapping traveling area or time to elapse before the own vehicle reaches the overlapping traveling area. Meanwhile, in the presence of a plurality of overlapping traveling areas at one connection point, time to elapse before reaching each of these overlapping traveling areas or a distance to each of these overlapping traveling areas should be calculated. This increases a load on the projection controller 11. Further, projecting a plurality of images having different contents to the inside of one connection point potentially makes it difficult to recognize these images individually. In particular, in a situation that permits viewing of a plurality of images projected from an own vehicle simultaneously from another vehicle (at an intersection with good visibility, for example), care should be taken in the contents of images to be projected to each overlapping traveling area so as not to make a driver of the other vehicle disturbed.

### Fifth Embodiment

FIG. 25 is a block diagram showing the structure of a vehicle projection control system according to a fifth embodiment. Compared to the structure of the first embodiment (FIG. 1), this vehicle projection control system additionally includes a planned traveling route acquiring part 15 in the vehicle projection control device 10.

The planned traveling route acquiring part 15 has the function of acquiring a planned traveling route of an own vehicle. The planned traveling route of the own vehicle is acquired by search for a route from a current position to a destination. The planned traveling route acquiring part 15 is not required to have a route searching function. For example, the planned traveling route acquiring part 15 may be configured to acquire information about a planned traveling route searched for by a navigation system installed on the own vehicle.

In the vehicle projection control device 10 of the fifth embodiment, the overlapping traveling area detector 13 detects an overlapping traveling area existing on a planned traveling route of an own vehicle acquired by the planned traveling route acquiring part 15. Thus, the projection controller 11 operates in such a manner as to project an image to an overlapping traveling area existing on the planned traveling route of the own vehicle by using the projection device 20.

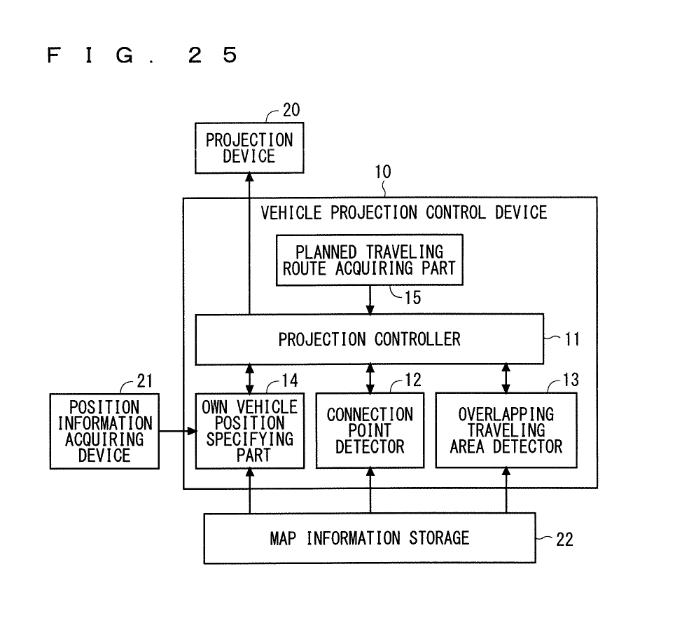

For example, if a planned traveling route of an own vehicle indicates that the own vehicle is to go straight ahead at the connection point P1 (intersection) shown in FIG. 10, for example, the overlapping traveling area detector 13 determines the areas A1 and A2 to be areas that permit traveling of the own vehicle. Then, the overlapping traveling area detector 13 detects the areas A1 and A2 as overlapping traveling areas overlapping between the areas A1 and A2 that permit traveling of the own vehicle and the areas A1 to A4 that permit traveling of the other vehicles C1 and C4. Thus, as shown in FIG. 26, the projection controller 11 projects a word “CAUTION” to each of the overlapping traveling areas A1 and A2.

If a planned traveling route of the own vehicle indicates that the own vehicle is to turn right at the connection point P1 of FIG. 10, the overlapping traveling area detector 13 determines the areas A1, A2, and A3 to be areas that permit traveling of the own vehicle. Then, the overlapping traveling area detector 13 detects the areas A1, A2 and A3 as overlapping traveling areas. However, it is desirable that an image be not projected to the area A3 in an opposite lane. Thus, in this case, the projection controller 11 also projects a word “CAUTION” to each of the overlapping traveling areas A1 and A2, as shown in FIG. 26.

If a planned traveling route of the own vehicle indicates that the own vehicle is to turn left at the connection point P1 of FIG. 10, the overlapping traveling area detector 13 determines the area A2 to be an area that permits traveling of the own vehicle. Then, the overlapping traveling area detector 13 detects the area A2 as an overlapping traveling area. Thus, in this case, the projection controller 11 projects a word “CAUTION” only to the overlapping traveling area A2, as shown in FIG. 27.

In the fifth embodiment, the projection controller 11 projects an image by using the projection device 20 to an overlapping traveling area that is limited to an area on a planned traveling route of an own vehicle. This achieves efficient image projection. Further, the probability of image projection to an area not requiring such projection is reduced. This is expected to achieve further effect of facilitating recognition of a projected image.

The planned traveling route acquiring part 15 may be a simple part as long as it can recognize a planned traveling route of an own vehicle. For example, based on an operated condition of a direction indicator (blinker) of the own vehicle, the planned traveling route acquiring part 15 may determine a planned traveling route at a connection point immediately before the own vehicle reaches this connection point.

### Sixth Embodiment

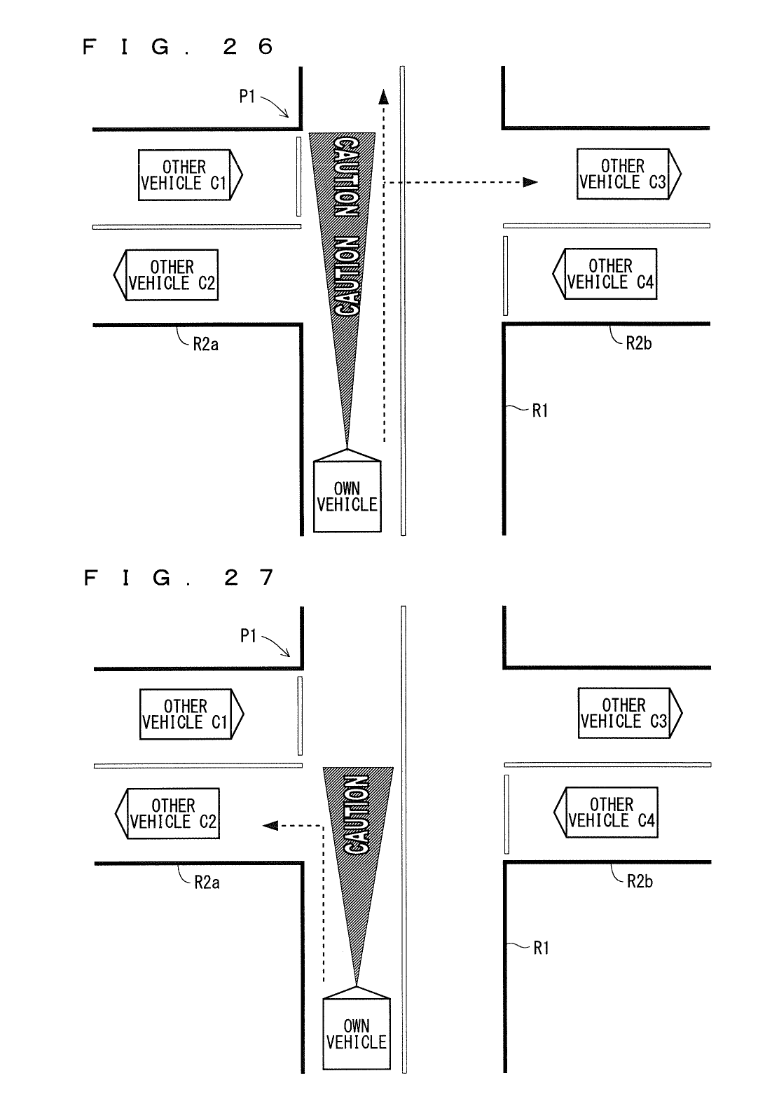

FIG. 28 is a block diagram showing the structure of a vehicle projection control system according to a sixth embodiment. Compared to the structure of the first embodiment (FIG. 1), this vehicle projection control system additionally includes an other vehicle detector 16 in the vehicle projection control device 10.

The other vehicle detector 16 has the function of detecting the existence of another vehicle traveling on a connected road toward an own vehicle traveling road. The other vehicle detector 16 may detect such another vehicle by any way. For example, the other vehicle detector 16 may employ a method of detecting another vehicle traveling toward an own vehicle traveling road based on position information about the other vehicle and information about the traveling direction of the other vehicle received by a communication device that makes communication with the other vehicle (what is called “vehicle-to-vehicle communication”). The other vehicle detector 16 may additionally employ a method of detecting another vehicle by analyzing an image of a surrounding of an own vehicle captured by an on-board camera, a method of detecting another vehicle traveling on a connected road toward an own vehicle traveling road based on various types of sensor information acquired by an on-board sensor, or a combination of two or more of these methods, for example.

In particular, if another vehicle is assumed to have the vehicle projection control device 10 of the present invention, the existence of the other vehicle may be detected by capturing an image projected from the other vehicle to an overlapping traveling area at a connection point by using a camera installed on an own vehicle and analyzing the captured image. For the detection, various types of information indicated by the image projected from the other vehicle may be recognized. For example, if the image projected from the other vehicle shows a distance from the other vehicle to a connection point or an overlapping traveling area or time to elapse before the other vehicle reaches the connection point or the overlapping traveling area, the position or the traveling direction of the other vehicle can be recognized based on such information indicated by the image.

In the vehicle projection control device 10 of the sixth embodiment, the overlapping traveling area detector 13 detects an overlapping area that permits traveling of another vehicle detected by the other vehicle detector 16 (another vehicle traveling on a connected road toward an own vehicle traveling road).

For example, if the other vehicles C1 to C4 are actually traveling as shown in FIG. 10 at the connection point P1 of FIG. 10, the other vehicle detector 16 detects the other vehicles C1 and C4 traveling on the connected roads R2a and R2b respectively toward the connection point P1 with the own vehicle traveling road R1 (the other vehicles C2 and C3 are traveling in directions away from the own vehicle traveling road R1, so that they are not to be detected by the other vehicle detector 16). An area that permits traveling of the other vehicle C1 includes the areas A1, A3, and A4. An area that permits traveling of the other vehicle C4 includes the areas A1, A2, and A4. Further, an area that permits traveling of an own vehicle includes the areas A1, A2, and A3. Thus, the overlapping traveling area detector 13 detects the areas A1, A2, and A3 as overlapping traveling areas overlapping between the areas A1, A2, and A3 that permit traveling of the own vehicle and the areas A1 to A4 that permit traveling of the other vehicles C1 and C4. However, an image is not to be projected to the area A3 in an opposite lane. Thus, like in FIG. 11, the projection controller 11 projects an image (word “CAUTION”) to each of the overlapping traveling areas A1 and A2 by using the projection device 20.

As shown in FIG. 29, if the other vehicles C1 and C4 traveling toward the own vehicle traveling road R1 are omitted from the connection point P1 of FIG. 10, the other vehicle detector 16 does not detect another vehicle. As no other vehicle is detected by the other vehicle detector 16, the overlapping traveling area detector 13 does not detect an overlapping traveling area. Thus, in this case, the projection controller 11 does not project an image, as shown in FIG. 29.

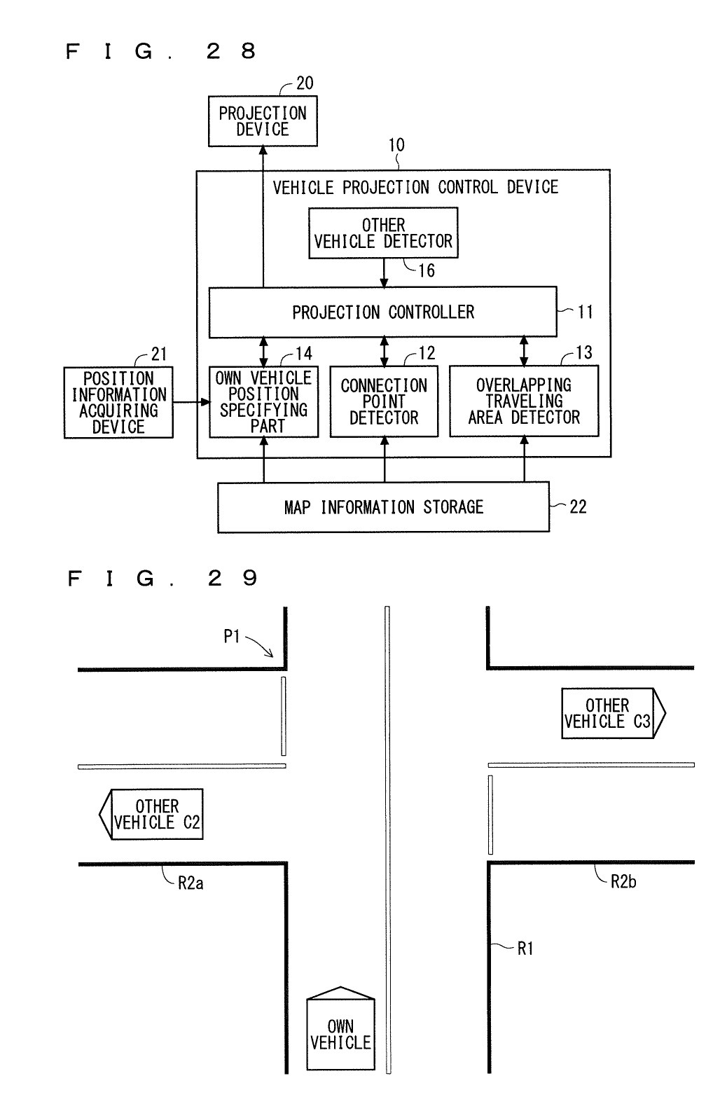

As shown in FIG. 30, if there exists only the other vehicle C1 as another vehicle traveling toward the own vehicle traveling road R1 at the connection point P1 of FIG. 10, the other vehicle C1 is detected by the other vehicle detector 16. An area that permits traveling of the other vehicle C1 includes the areas A1, A3, and A4. An area that permits traveling of an own vehicle includes the areas A1, A2, and A3. Thus, the overlapping traveling area detector 13 detects the areas A1 and A3 as overlapping traveling areas overlapping between the other vehicle C1 and the own vehicle. However, an image is not to be projected to the area A3 in an opposite lane. Thus, in this case, the projection controller 11 projects an image only to the overlapping traveling area A1 by using the projection device 20, as shown in FIG. 30.

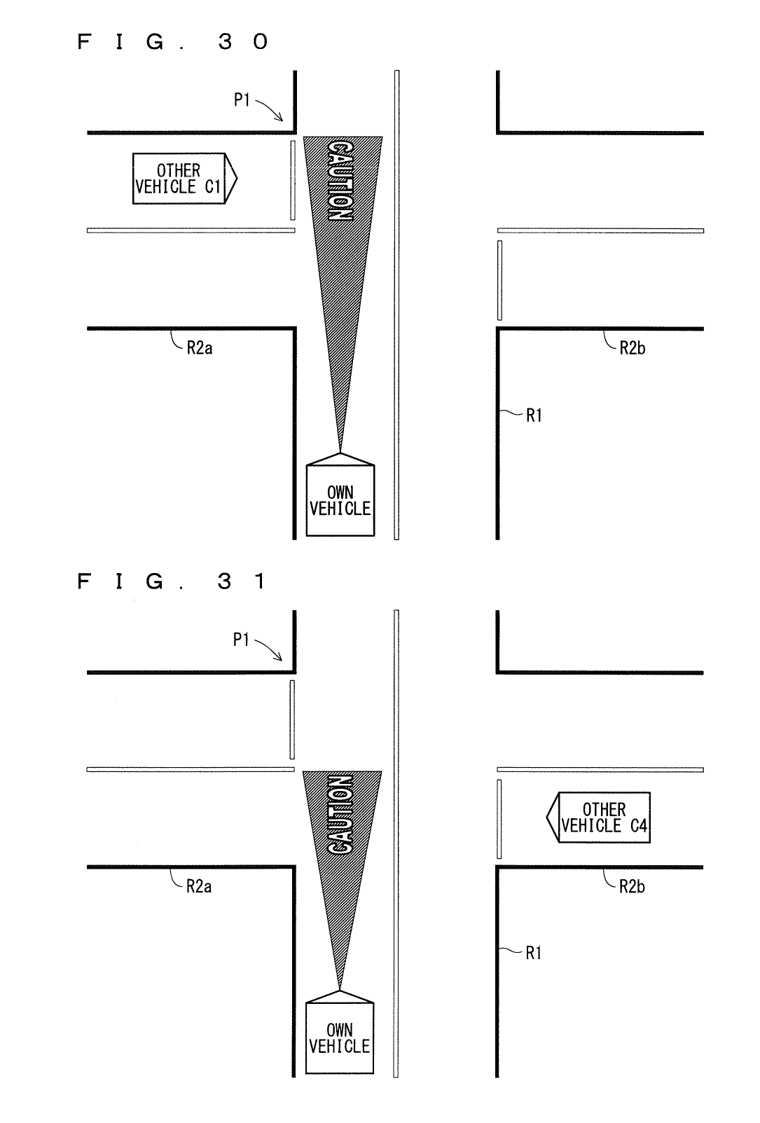

As shown in FIG. 31, if there exists only the other vehicle C4 as another vehicle traveling toward the own vehicle traveling road R1 at the connection point P1 of FIG. 10, the other vehicle C4 is detected by the other vehicle detector 16. An area that permits traveling of the other vehicle C4 includes the areas A1, A2, and A4. An area that permits traveling of an own vehicle includes the areas A1, A2, and A3. Thus, the overlapping traveling area detector 13 detects the areas A1 and A2 as overlapping traveling areas overlapping between the other vehicle C4 and the own vehicle. When the other vehicle C4 is to travel in the area A1 (turn right), the other vehicle C4 always passes through the area A2. Hence, projecting an image only to the area A2 will suffice. Thus, in this case, the projection controller 11 projects an image only to the overlapping traveling area A2 by using the projection device 20, as shown in FIG. 31.

In the sixth embodiment, the projection controller 11 projects an image by using the projection device 20 to an overlapping traveling area that is limited to an area that permits traveling of another vehicle actually detected. This achieves efficient image projection. Further, the probability of image projection to an area not requiring such projection is reduced. This is expected to achieve further effect of facilitating recognition of a projected image.

### Seventh Embodiment

FIG. 32 is a block diagram showing the structure of a vehicle projection control system according to a seventh embodiment. Compared to the structure of the sixth embodiment (FIG. 28), this vehicle projection control system additionally includes an other vehicle traveling direction estimating part 17.

The other vehicle traveling direction estimating part 17 has the function of estimating the traveling direction of another vehicle at a connection point detected by the other vehicle detector 16. The other vehicle traveling direction estimating part 17 may estimate the traveling direction of another vehicle by any way. For example, the other vehicle traveling direction estimating part 17 may employ a method of making an estimation based on information about a planned traveling route of another vehicle received by a communication device that makes communication with the other vehicle (what is called “vehicle-to-vehicle communication”). The other vehicle traveling direction estimating part 17 may additionally employ a method of making an estimation by detecting the operation of a direction indicator of another vehicle or a road sign indicating regulation on a traveling direction at a connection point based on an image of a surrounding of an own vehicle captured by an on-board camera or various types of sensor information acquired by an on-board sensor, a method of making an estimation based on information about regulation on a traveling direction at a connection point contained in contained in the map information, or a combination of two or more of these methods, for example.

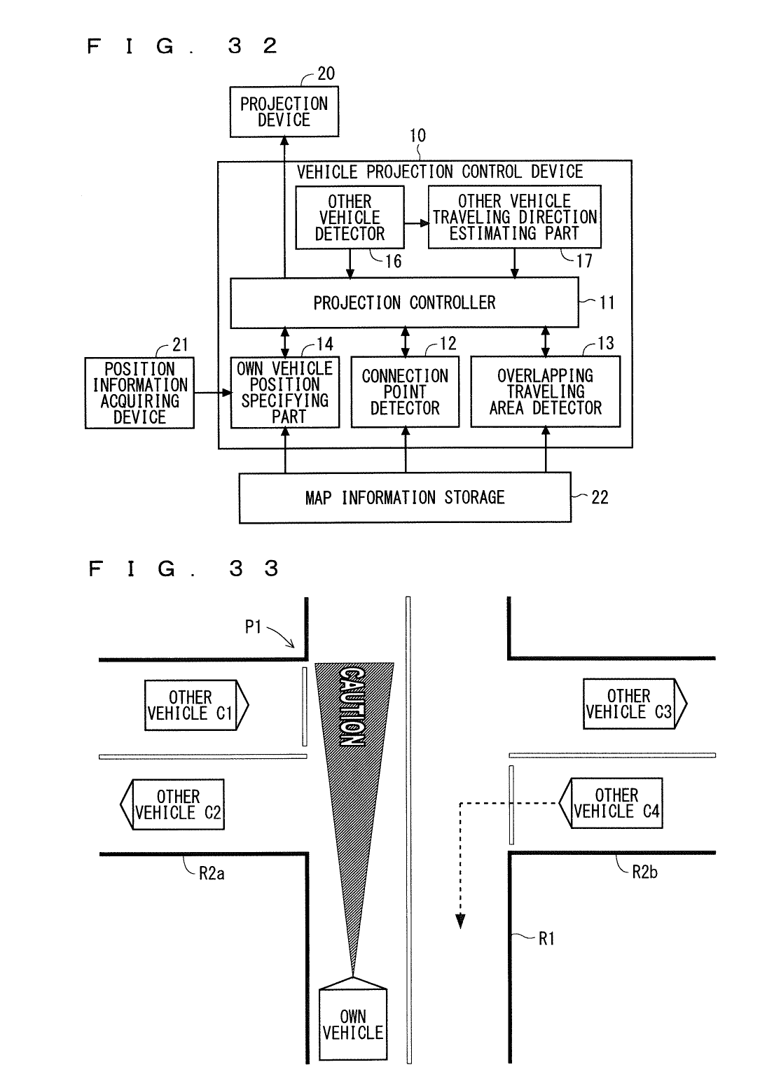

In the seventh embodiment, the overlapping traveling area detector 13 detects an overlapping traveling area based on the traveling direction of another vehicle at a connection point estimated by the other vehicle traveling direction estimating part 17. For example, if the other vehicles C1 to C4 are actually traveling as shown in FIG. 10 at the connection point P1 of FIG. 10 and the other vehicle C4 is expected to turn left at the connection point P1, only the area A4 can be determined to be an area that permits traveling of the other vehicle C4. Thus, the overlapping traveling area detector 13 detects the areas A1 and A3 as overlapping traveling areas overlapping between an own vehicle and the other vehicles C1 and C4. However, an image is not to be projected to the area A3 in an opposite lane. Thus, in this case, the projection controller 11 projects an image (word “CAUTION”) only to the overlapping traveling area A1 by using the projection device 20, as shown in FIG. 33.

The seventh embodiment achieves image projection with enhanced efficiency.

### Eighth Embodiment

FIG. 34 is a block diagram showing the structure of a vehicle projection control system according to an eighth embodiment. Compared to the structure of the seventh embodiment (FIG. 32), this vehicle projection control system additionally includes the planned traveling route acquiring part 15 described in the fifth embodiment in the vehicle projection control device 10. Specifically, in this embodiment, the overlapping traveling area detector 13 detects an overlapping traveling area in consideration of both a planned traveling route of an own vehicle acquired by the planned traveling route acquiring part 15 and the traveling direction of another vehicle at a connection point estimated by the other vehicle traveling direction estimating part 17.

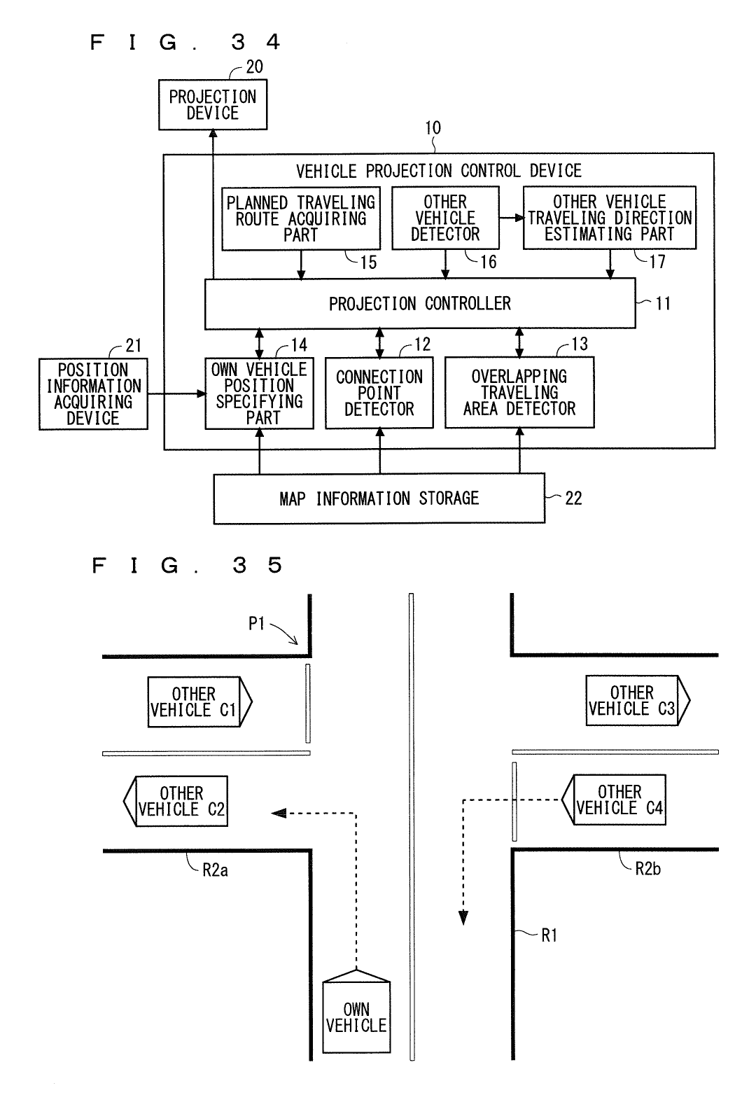

For example, if the other vehicles C1 to C4 are actually traveling as shown in FIG. 10 at the connection point P1 of FIG. 10, an own vehicle is to turn left at the connection point P1 according to a planned traveling route of the own vehicle, and the other vehicle C4 is expected to turn left at the connection point P1, it can be determined that there is no overlapping traveling area overlapping between the own vehicle and the other vehicles C1 and C4. Thus, the overlapping traveling area detector 13 does not detect an overlapping traveling area and the projection controller 11 does not project an image, as shown in FIG. 35.

The eighth embodiment achieves image projection with enhanced efficiency.

### Ninth Embodiment

FIG. 36 is a block diagram showing the structure of a vehicle projection control system according to a ninth embodiment. Compared to the structure of the sixth embodiment (FIG. 28), this vehicle projection control system additionally includes a warning part 101 and a traveling controller 102 in the vehicle projection control device 10. The warning part 101 has the function of issuing a warning to a driver. The traveling controller 102 has the function of controlling a vehicle driver 26 for making an own vehicle travel.

In the vehicle projection control device 10 of the ninth embodiment, the other vehicle detector 16 detects the existence of another vehicle traveling on a connected road toward a connection point existing ahead of an own vehicle in a traveling direction. Further, the other vehicle detector 16 determines whether or not the detected other vehicle is to enter the same overlapping traveling area as the own vehicle simultaneously with the own vehicle based on the traveling direction or the speed of the detected other vehicle. If the other vehicle detector 16 detects the existence of the other vehicle traveling on the connected road to enter the same overlapping traveling area as the own vehicle simultaneously with the own vehicle, the warning part 101 issues a warning indicating the existence of this other vehicle to a driver. Further, if the other vehicle detector 16 detects the existence of the other vehicle traveling on the connected road to enter the same overlapping traveling area as the own vehicle simultaneously with the own vehicle, the traveling controller 102 controls the vehicle driver 26 so as to make the own vehicle decelerate or make a temporary stop.

By doing so, collision between the own vehicle and the other vehicle can be prevented. When the traveling controller 102 makes the own vehicle decelerate or make a temporary stop, the warning part 101 issues a warning. In this way, a driver can be notified of the fact that this deceleration or temporary stop is being made under the command of the traveling controller 102.

According to the example shown in this embodiment, both the warning part 101 and the traveling controller 102 are provided in the vehicle projection control device 10. Alternatively, only one of the warning part 101 and the traveling controller 102 may be provided in the vehicle projection control device 10.

### Tenth Embodiment

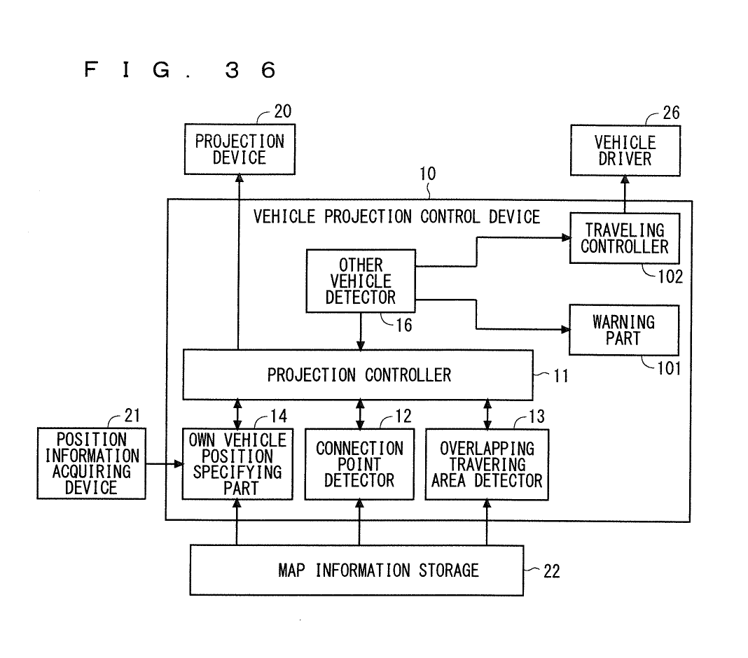

FIG. 37 is a block diagram showing the structure of a vehicle projection control system according to a tenth embodiment. Compared to the structure of the eighth embodiment (FIG. 34), this vehicle projection control system additionally includes the warning part 101 and the traveling controller 102 in the vehicle projection control device 10.

The basic operation of the vehicle projection control device 10 of the tenth embodiment is the same as that of the ninth embodiment. Meanwhile, the warning part 101 and the traveling controller 102 determine whether or not another vehicle traveling on a connected road is to enter the same overlapping traveling area as an own vehicle simultaneously with the own vehicle in consideration of both a planned traveling route of the own vehicle acquired by the planned traveling route acquiring part 15 and the traveling direction of the other vehicle at a connection point estimated by the other vehicle traveling direction estimating part 17. For example, while the other vehicle traveling on the connected road and the own vehicle are to enter the same connection point simultaneously, a planned traveling route of the own vehicle and a traveling route of the other vehicle expected from the traveling direction of the other vehicle may not overlap each other, as in the illustration of FIG. 35. In this case, the warning part 101 and the traveling controller 102 do not operate.

The tenth embodiment makes it possible to minimize the frequency of issuance of a warning by the warning part 101 or the frequency of operation of the traveling controller 102 for deceleration of an own vehicle, etc. In this way, it is less likely that a driver will feel these operations as redundant.

### Eleventh Embodiment

In the examples of the aforementioned embodiments, the own vehicle traveling road R1 is described as a one-lane or two-lane road. The present invention is also applicable to the case where the own vehicle traveling road R1 is a three-lane road or roads of more lanes. An eleventh embodiment shows an example of preferable operation of the vehicle projection control device 10 in the case where the own vehicle traveling road R1 is a four-lane road of two-lane each way.

As shown in FIG. 38, it is assumed, for example, that there is a connection point P1 where a two-lane (one-lane each way) connected road R2a is connected to the left side of an own vehicle traveling road R1 that is a four-lane road of two-lane each way and a two-lane (one-lane each way) connected road R2b is further connected to the right side of the own vehicle traveling road R1.

In the vehicle projection control device 10, if the connection point detector 12 detects the connection point P1 existing ahead of an own vehicle in a traveling direction, the overlapping traveling area detector 13 searches for an overlapping traveling area in the connection point P1. More specifically, the overlapping traveling area detector 13 divides the connection point P1 into four-by-two areas A1 to A8 shown in FIG. 38 and determines whether or not each of these areas is an overlapping traveling area.

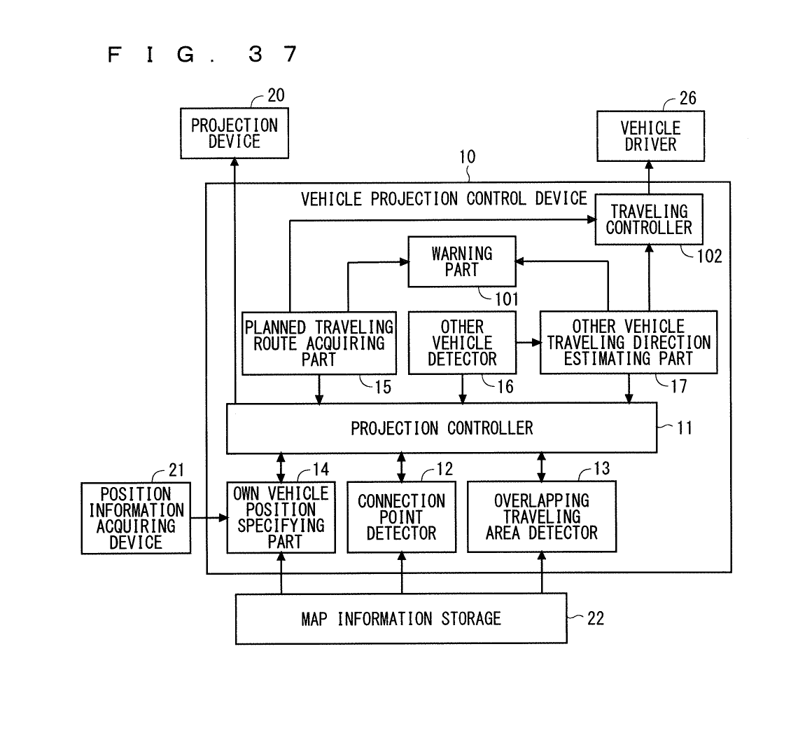

Referring to FIG. 38, the own vehicle can turn right, turn left, and change a lane. The other vehicles C1 and C4 to enter the connection point P1 can go straight ahead. Thus, the areas A1 to A4, A5, and A7 theoretically become overlapping traveling areas. However, in consideration of risk of interfering with traveling of a vehicle traveling on an adjacent lane or an opposite lane caused by projecting an image to such lanes and in consideration of the fact that a lane is usually not changed so frequently, it is desirable that an image be projected only to an overlapping traveling area (areas A1 and A2) in a lane in which the own vehicle is traveling, as shown in FIG. 39.

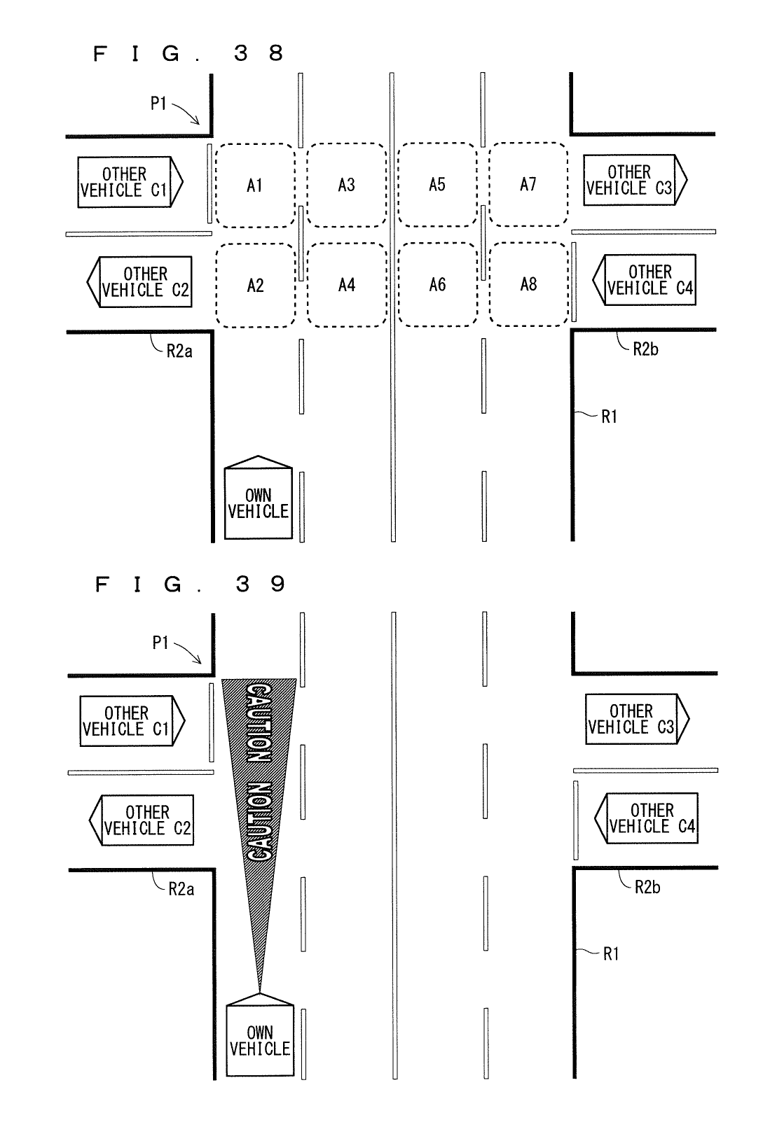

If there is a median strip D1 at the connection point P1 as in FIG. 40, an own vehicle is prohibited from turning right at the connection point P1. Thus, the areas A1 to A4 become areas that permit traveling of the own vehicle. Further, the other vehicles C1 and C4 to enter the connection point P1 from the connected roads R2a and R2b respectively are only permitted to turn left. Hence, the areas A1 and A3 become areas that permit traveling of the other vehicle C1, whereas the areas A6 and A8 become areas that permit traveling of the other vehicle C4. Thus, the areas A1 and A3 are determined to be overlapping traveling areas. In this case, it is also desirable that an image be projected only to an overlapping traveling area (area A1) in a lane in which the own vehicle is traveling, as shown in FIG. 41.

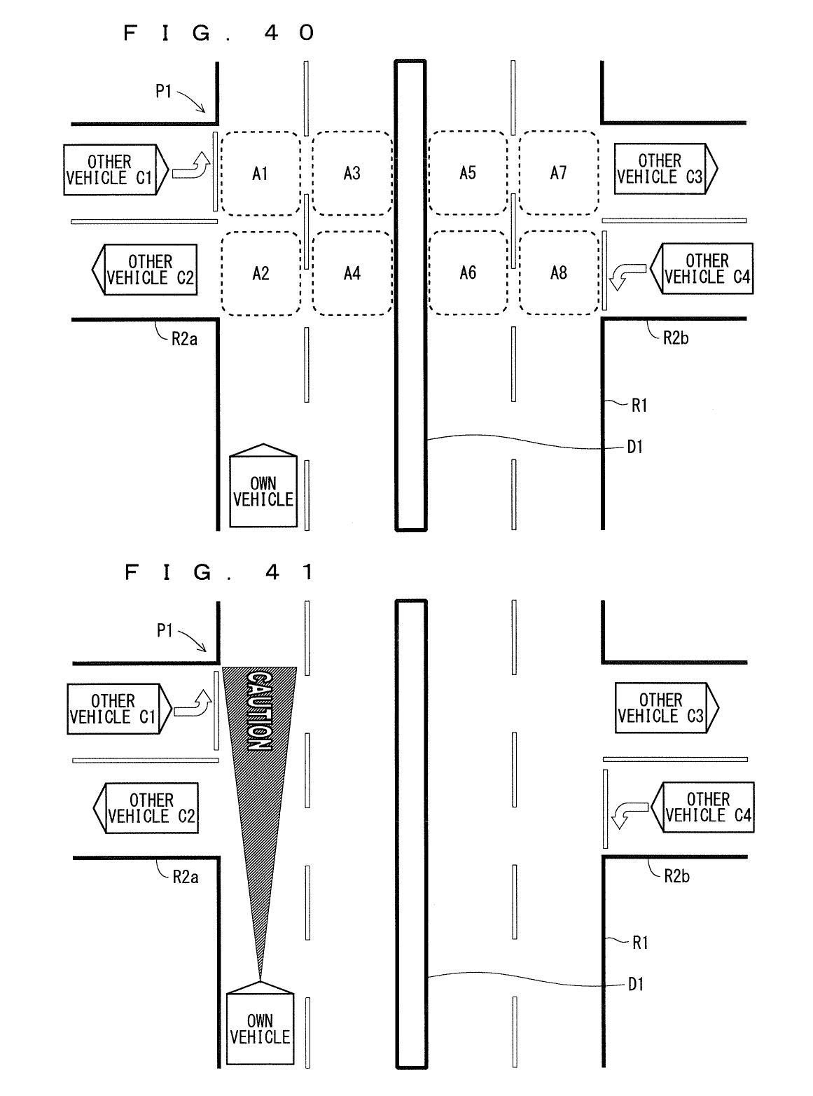

Referring to the connection point P1 of FIG. 40, it is not likely that the other vehicle C1 to enter the connection point P1 from the connected road R2a will directly enter a lane closer to the median strip D1. Thus, the area A3 at the connection point P1 of FIG. 40 can be considered not to be an area that permits traveling of the other vehicle C1. In this case, only the area A1 becomes an overlapping traveling area. Hence, if the own vehicle is traveling in a lane closer to the median strip D1 as shown in FIG. 42, no overlapping traveling area exists in this lane and no image is to be projected accordingly.

### Twelfth Embodiment

FIG. 43 is a block diagram showing the structure of a vehicle projection control system according to a twelfth embodiment. Compared to the structure of the first embodiment (FIG. 1), this vehicle projection control system additionally includes a connection angle determining part 18 in the vehicle projection control device 10.

In the twelfth embodiment, the map information stored in the map information storage 22 contains information about a connection angle of each road. The connection angle determining part 18 determines a connection angle at a connection point detected by the connection point detector 12 between an own vehicle traveling road and a connected road based on the information about a connection angle of each road contained in the map information.

The operation of the vehicle projection control device 10 according to the twelfth embodiment is descried in detail. If the existence of a connection point between an own vehicle traveling road and a connected road is detected ahead of an own vehicle in a traveling direction, the vehicle projection control device 10 projects an image (word “CAUTION”) to the connection point by using the projection device 20.

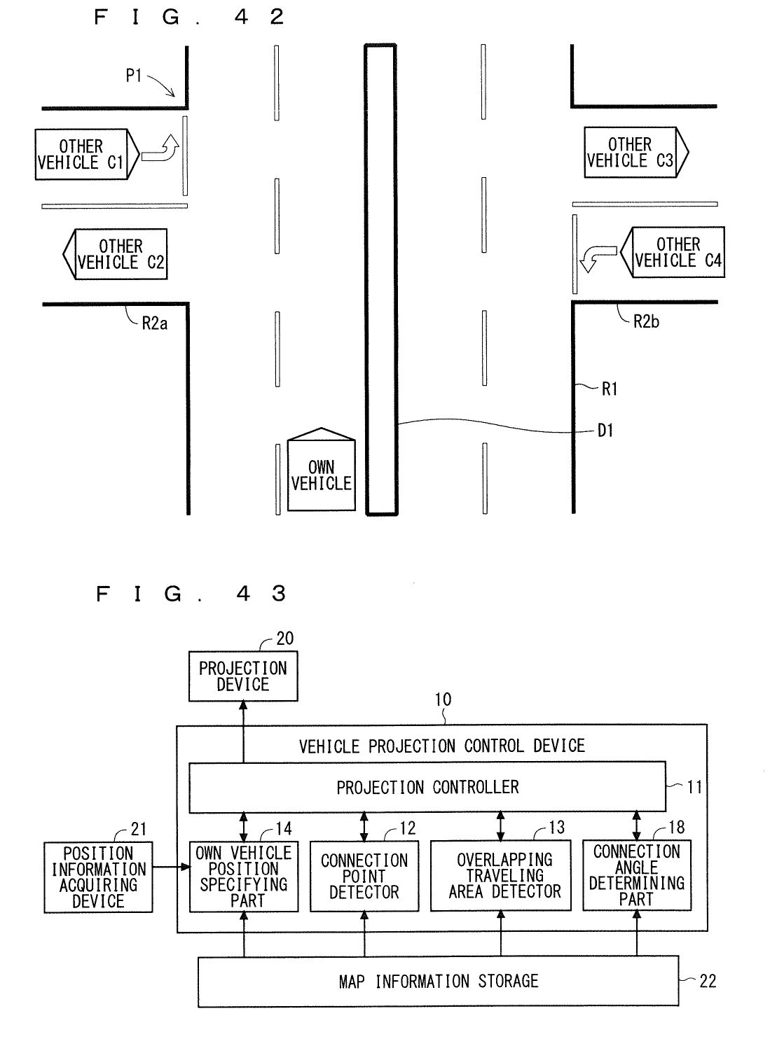

At this time, the projection controller 11 adjusts the orientation of an image to be projected based on a connection angle at the connection point between the own vehicle traveling road and the connected road. If a connected road R2 is connected diagonally to an own vehicle traveling road R1 as shown in FIG. 44 or 45, for example, the projection controller 11 adjusts the orientation of the word “CAUTION” so as to conform to an angle of the diagonal connection to place the word “CAUTION” in an orientation in which the word “CAUTION” is viewed in a correct posture from the connected road R2. Then, the projection controller 11 projects the word “CAUTION” to the connection point P1. Specifically, the word “CAUTION” is rotated so as to conform to a direction in which the connected road R2 is connected to the own vehicle traveling road R1.

In this way, the orientation of an image to be projected to the connection point P1 is adjusted in such a manner that the image can be viewed in a correct posture from the connected road R2. This allows this image to be recognized easily by a driver of another vehicle or a pedestrian on the connected road R2.

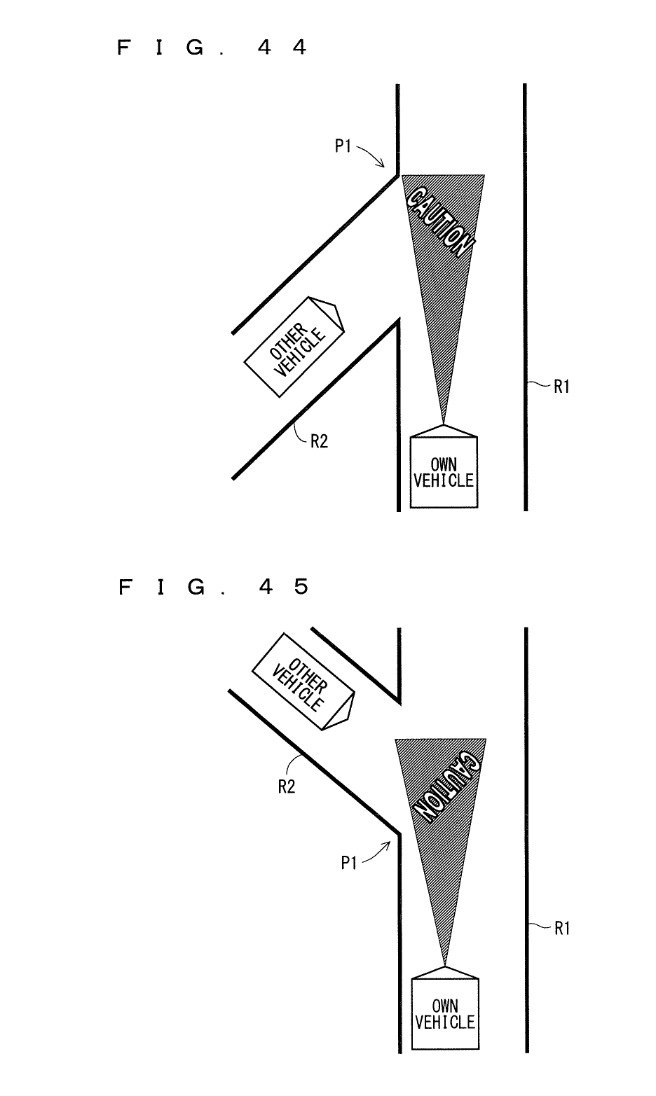

This embodiment works effectively for example for image projection to the connection point P1 (Y-shaped road or three-way intersection), etc. where two connected roads R2a and R2b are connected from diagonal directions to the terminal of the own vehicle traveling road R1, as shown in FIG. 46. In the case of the connection point P1 as a Y-shaped road, the overlapping traveling area detector 13 may divide the connection point P1 into three areas A1 to A3, as shown in FIG. 46.

In this case, an own vehicle passes through the area A2 for turning left and passes through the areas A1 and A2 for turning right. The other vehicle C1 to enter the connection point P1 from the connected road R2a passes through the area A1 for turning left and passes through the areas A1 and A3 for turning right. The other vehicle C4 to enter the connection point P1 from the connected road R2b passes through the area A3 for turning left and passes through the areas A2 and A3 for turning right. Thus, the overlapping traveling area detector 13 of the own vehicle determines the areas A1 and A2 to be overlapping traveling areas at the connection point P1. As a result, the projection controller 11 projects an image to each of the areas A1 and A2 by using the projection device 20. At this time, the orientation of the image to be projected to the area A1 as an area overlapping between the own vehicle and the other vehicle C1 is adjusted in such a manner that this image is viewed in a correct posture from the connected road R2a on which the other vehicle C1 is traveling. The orientation of the image to be projected to the area A2 as an area overlapping between the own vehicle and the other vehicle C4 is adjusted in such a manner that this image is viewed in a correct posture from the connected road R2b on which the other vehicle C4 is traveling.

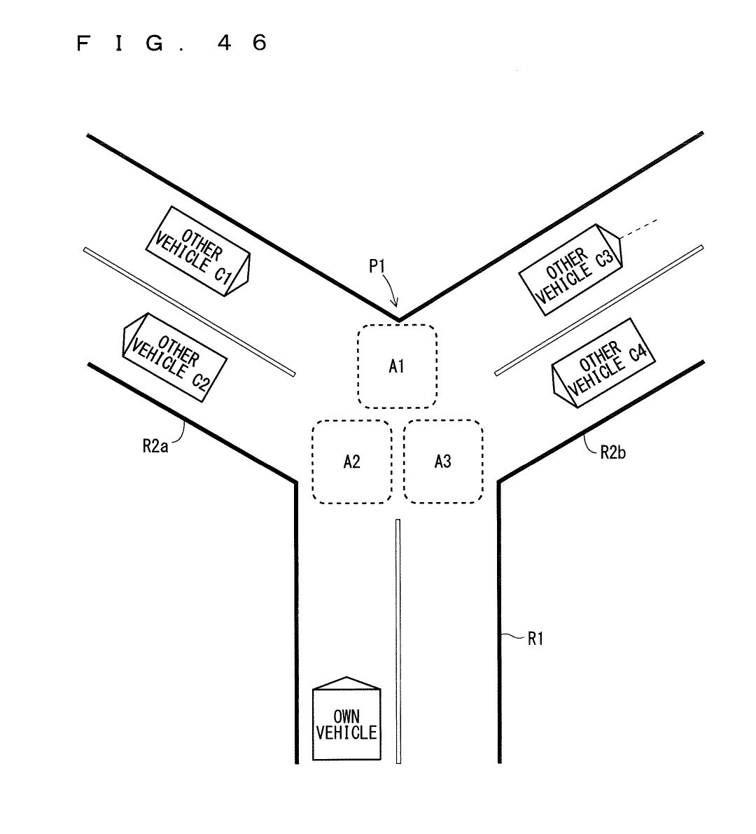

FIG. 48 is a flowchart showing the operation of the vehicle projection control device 10 according to the twelfth embodiment. The aforementioned operations are realized by implementation of processes shown in FIG. 48 by the vehicle projection control device 10. The flowchart of FIG. 48 includes step S21 and step S22 added between steps S15 and S16 in the flowchart of FIG. 13. The description of the steps except steps S21 and S22 will be omitted. The processes of FIG. 48 are finished in response to an action for finishing these processes taken by a user on the vehicle projection control device 10, input of a command given from a different device instructing finish of these processes to the vehicle projection control device 10, or receipt of a command instructing finish of these processes given from a different process performed by the vehicle projection control device 10, for example.

In step S21, the connection angle determining part 18 determines a connection angle between an own vehicle traveling road and a connected road at a connection point detected in step S11. In step S22, the projection controller 11 decides the orientation of an image to be projected to this connection point based on a result of the determination about the connection angle. Thus, in step S16, the image adjusted in the orientation decided in step S15 is projected to an overlapping traveling area detected in step S14.

Referring to FIG. 43, the connection angle determining part 18 is provided in the vehicle projection control device 10 having the structure of the first embodiment (FIG. 1). The connection angle determining part 18 determines a connection angle with a road based on the map information stored in the map information storage 22. However, the process of determining a connection angle between roads by the connection angle determining part 18 can be performed in a different way.

For example, if an infrastructure such as a beacon to distribute traffic information is developed and a distribution facility to distribute position information about a connection point and information about a connection angle between roads at this connection point is installed at every place of a road network, each of the processes by the connection angle determining part 18 may be performed based on information acquired as a result of communication with each distribution facility. In this case, the connection angle determining part 18 may be provided in the vehicle projection control device 10 shown in FIG. 14 and the connection angle determining part 18 may determine a connection angle between an own vehicle traveling road and a connected road based on information about a connection angle between roads acquired by the communication device 23 from the distribution facility, for example.

As another example, the connection angle determining part 18 may determine a connection angle between roads based on a result of analysis on an image of a surrounding of an own vehicle taken by an on-board camera. In this case, the connection angle determining part 18 may be provided in the vehicle projection control device 10 shown in FIG. 15 and the connection angle determining part 18 may determine a connection angle between an own vehicle traveling road and a connected road based on a result of analysis on an image in the image taken by the on-board camera, for example.

As another example, the connection angle determining part 18 may determine a connection angle between roads based on information acquired by an on-board sensor. In this case, the connection angle determining part 18 may be provided in the vehicle projection control device 10 shown in FIG. 16 and the connection angle determining part 18 may determine a connection angle between an own vehicle traveling road and a connected road based on a result of analysis on sensor information, for example.

### Thirteenth Embodiment

FIG. 49 is a block diagram showing the structure of a vehicle projection control system according to a thirteenth embodiment. Compared to the structure of the first embodiment (FIG. 1), this vehicle projection control system additionally includes a precedence relationship determining part 19 in the vehicle projection control device 10.

In the thirteenth embodiment, the map information stored in the map information storage 22 contains information about a precedence relationship between roads. The precedence relationship determining part 19 determines a precedence relationship between an own vehicle traveling road and a connected road at a connection point detected by the connection point detector 12 based on the information about a precedence relationship between roads contained in the map information.

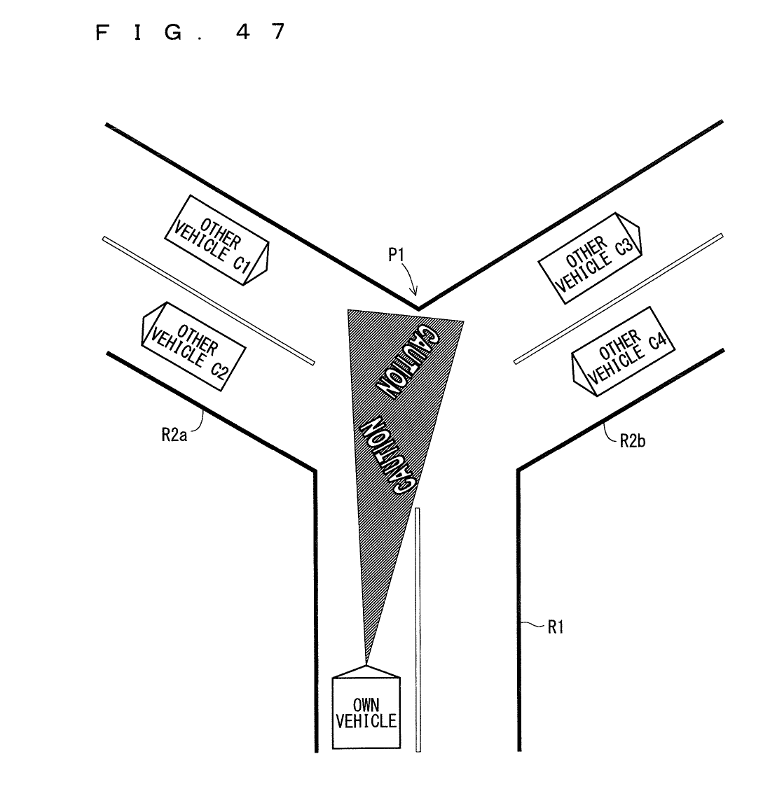

A precedence relationship described herein is about roads without signals. A precedence relationship between roads is generally defined by a road sign (including a road marking) or a road width. For example, if only the center line of a road R1 extends continuously without being cut at a connection point P1 between the road R1 and a road R2 as shown in (a) of FIG. 50 or if a stop line is provided only to the road R2 at the connection point P1 as shown in (b) of FIG. 50 the road R1 is given precedence over the road R2. Specifically, the traffic of a vehicle A traveling on the road R1 is given precedence over the traffic of a vehicle B traveling on the road R2. If the width of the road R1 is clearly larger than that of the road R2 as shown in (c) of FIG. 50, the road R1 is given precedence over the road R2 even in the absence of a road sign, etc. at the connection point P1.

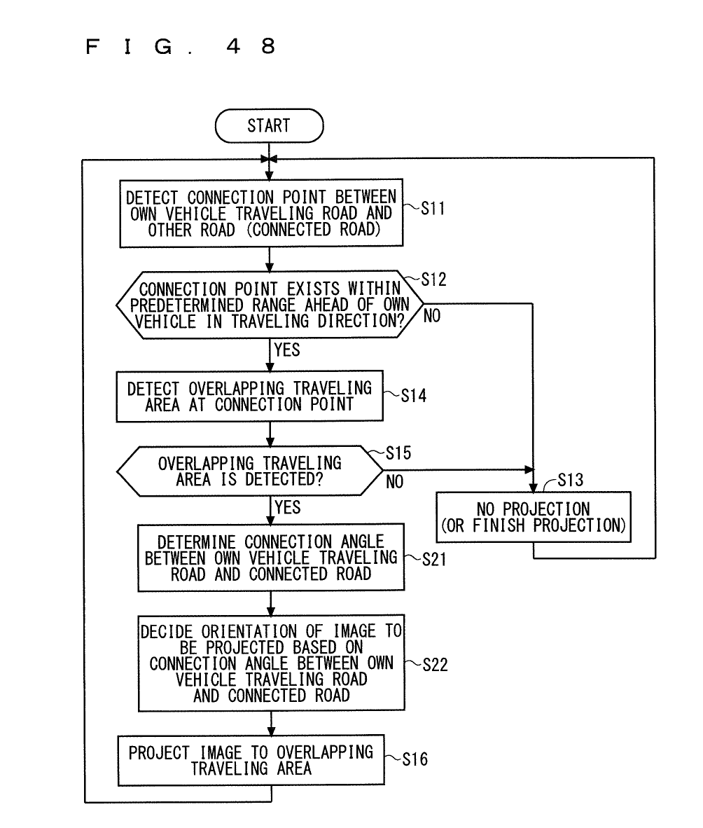

If both the center lines of the roads R1 and R2 are cut at the connection point P1 as shown in (a) of FIG. 51 or if both the roads R1 and R2 have respective stop lines at the connection point P1 as shown in (b) of FIG. 51, a precedence relationship is not established between the roads R1 and R2 (the roads R1 and R2 have the same precedence). If there is no road sign and if there is no clear difference in road width between the roads R1 and R2 as shown in (c) of FIG. 51, a precedence relationship between the roads R1 and R2 is unknown (there is generally no precedence relationship therebetween). In this case, both the vehicles A and B are required to stop temporarily or reduce their speeds before the connection point P1 to give way to each other during traveling. (In some countries, a precedence relationship in terms of traffic to be employed in such a case is defined. Referring to the case of Japan, for example, if both the vehicles A and B are to go straight ahead, precedence is basically given to the traffic of the vehicle B to enter the connection point P1 from the left side.) The examples of a precedence relationship shown in FIGS. 50 and 51 are further applicable to drawings referred to hereinbelow.

The projection controller 11 of the vehicle projection control device 10 according to the thirteenth embodiment changes a projection pattern of an image to be projected to an overlapping traveling area at a connection point in a manner that depends on a precedence relationship between an own vehicle traveling road and a connected road at this connection point. The “projection pattern” of an image mentioned herein means a projection style of an image determined by one or more of the following elements: the color and the brightness of light for projecting the image, the shape of the image to be projected to a road surface, and the type of the image to be projected to a road surface (character, symbol, or graphic object, for example).

In the thirteenth embodiment, three different projection patterns are defined in a manner that depends on a precedence relationship between an own vehicle traveling road and a connected road. FIG. 52 shows these three projection patterns. The projection controller 11 determines a projection pattern including an image (here, word “CAUTION”) drawn by using red light as shown in (a) of FIG. 52 to be a projection pattern to be employed for projection of an image to an overlapping traveling area at a connection point where an own vehicle traveling road is given precedence over a connected road (first projection pattern). The projection controller 11 determines a projection pattern including an image drawn by using green light as shown in (b) of FIG. 52 to be a projection pattern to be employed for projection of an image to an overlapping traveling area at a connection point where a connected road is given precedence over an own vehicle traveling road (second projection pattern). The projection controller 11 determines a projection pattern including an image drawn by using yellow light as shown in (c) of FIG. 52 to be a projection pattern to be employed for projection of an image to an overlapping traveling area at a connection point where an own vehicle traveling road and a connected road have the same precedence or a precedence relationship between these roads is unknown (third projection pattern).

Here, red, green, and yellow are selected for the projection patterns based on the idea of a signal. However, the structure of each of the projection patterns can be determined arbitrarily as long as these projection patterns can be distinguished from each other. Red or orange are generally recognized as colors indicating warning or prohibition, yellow is generally recognized as a color indicating attention, and green and blue are generally recognized as colors indicating permission. A projected image is not limited to a word “CAUTION” but it may alternatively be an image showing a distance from an own vehicle to a connection point or an overlapping traveling area or an image showing time to elapse before the own vehicle reaches the connection point or the overlapping traveling area, as described in the fourth embodiment. Further, the first to third projection patterns may include images differing from each other.

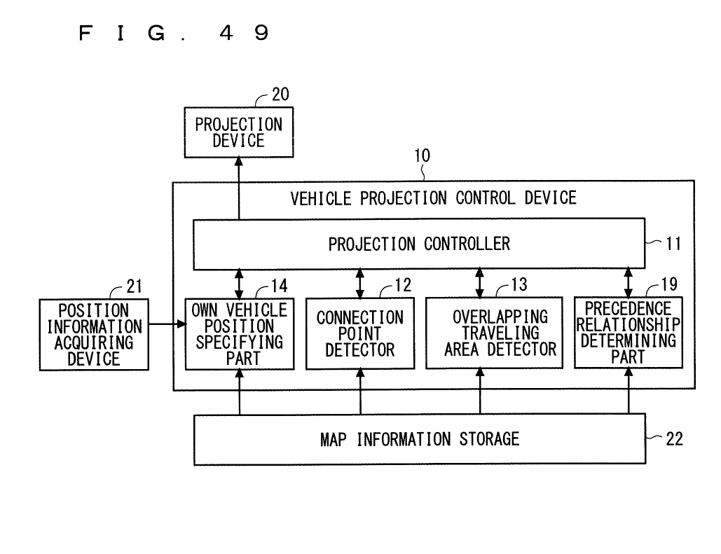

Next, the operation of the vehicle projection control device 10 according to the thirteen embodiment is descried in detail. If the existence of the connection point P1 between the own vehicle traveling road R1 and the connected road R2 is detected ahead of an own vehicle in a traveling direction, the vehicle projection control device 10 projects an image to an overlapping traveling area at this connection point P1 by using the projection device 20. At this time, if the own vehicle traveling road R1 is given precedence over the connected road R2 as shown in FIG. 53, an image is projected to an overlapping traveling area at the connection point P1 according to the first projection pattern (red). By doing so, a driver of another vehicle or a pedestrian on the connected road R2 can be notified of the approach of the own vehicle toward the connection point P1 and warned of the precedence of the traffic of the own vehicle.

If the connected road R2 is given precedence over the own vehicle traveling road R1 as shown in FIG. 54, an image is projected to an overlapping traveling area at the connection point P1 according to the second projection pattern (green). By doing so, a driver of another vehicle or a pedestrian on the connected road R2 can be notified of the approach of the own vehicle toward the connection point P1 and can be notified of the precedence of the traffic of the other vehicle on the connected road R2 over the traffic of the own vehicle.

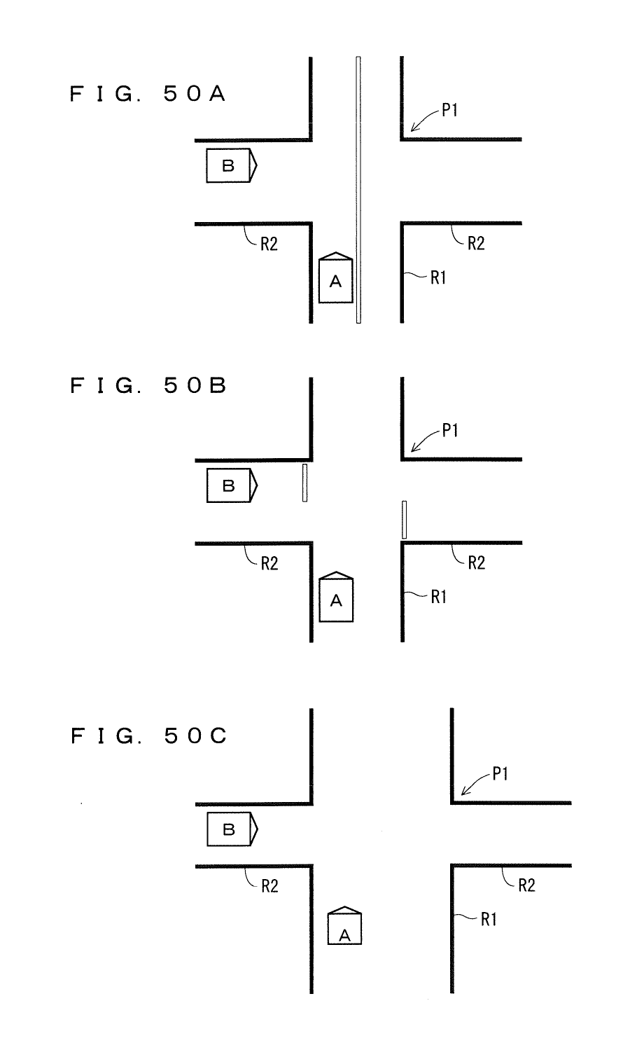

If the own vehicle traveling road R1 and the connected road R2 have the same precedence as shown in FIG. 55 or if a precedence relationship between these roads is unknown, an image is projected to an overlapping traveling area at the connection point P1 according to the third projection pattern (yellow). By doing so, a driver of another vehicle or a pedestrian on the connected road R2 can be notified of the approach of the own vehicle toward the connection point P1, so that the driver of the other vehicle or the pedestrian can be urged to be cautious.

FIG. 56 is a flowchart showing the operation of the vehicle projection control device 10 according to the thirteenth embodiment. The operations described by referring to FIGS. 53 to 55 are realized by implementation of processes shown in FIG. 56 by the vehicle projection control device 10. The flowchart of FIG. 56 includes step S31 and step S32 added between steps S15 and S16 in the flowchart of FIG. 13. The description of the steps except steps S31 and S32 will be omitted. The processes of FIG. 56 are finished in response to an action for finishing these processes taken by a user on the vehicle projection control device 10, input of a command given from a different device instructing finish of these processes to the vehicle projection control device 10, or receipt of a command instructing finish of these processes given from a different process performed by the vehicle projection control device 10, for example.

In step S31, the precedence relationship determining part 19 determines a precedence relationship between an own vehicle traveling road and a connected road at a connection point detected in step S11. In step S32, the projection controller 11 decides a projection pattern of an image to be projected to this connection point based on a result of this determination. Thus, in step S16, the image is projected to an overlapping traveling area detected in step S14 according to the projection pattern decided in step S32.

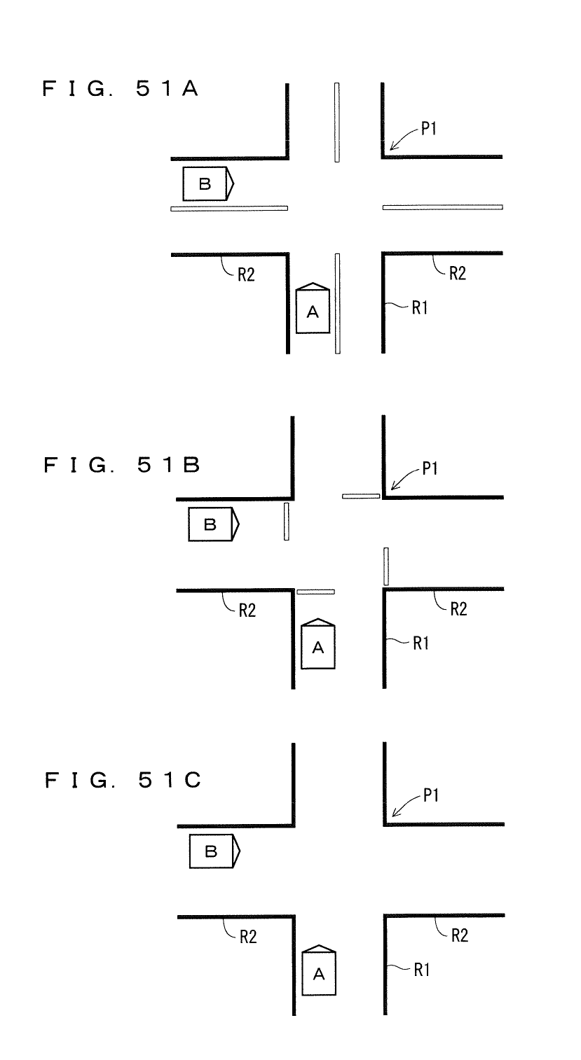

FIG. 57 is a flowchart showing the process in step S32 for deciding the projection pattern of the image to be projected to the overlapping traveling area at the connection point by the projection controller 11 (projection pattern deciding process).

In the projection pattern deciding process, the precedence relationship between the own vehicle traveling road and the connected road is checked first (step S321). In the thirteenth embodiment, if the own vehicle traveling road is given precedence over the connected road, the projection controller 11 decides to employ the first projection pattern (the projection pattern in red shown in (a) of FIG. 52) (step S322). If the connected road is given precedence over the own vehicle traveling road, the projection controller 11 decides to employ the second projection pattern (the projection pattern in green shown in (b) of FIG. 52) (step S323). If the own vehicle traveling road and the connected road have the same precedence or a precedence relationship between these roads is unknown, the projection controller 11 decides to employ the third projection pattern (the projection pattern in yellow shown in (c) of FIG. 52) (step S324).

According to the vehicle projection control system of the thirteenth embodiment, a precedence relationship between an own vehicle traveling road and a connected road can be determined based on a projection pattern of an image projected to a connection point. A driver of an own vehicle can determine a precedence relationship between roads at the connection point based on the projection pattern of the image projected from the own vehicle. The image projected to the connection point is also recognized by a driver of another vehicle traveling on the connected road. Thus, the driver of the other vehicle can also be notified of the precedence relationship between roads. As a result, not only the driver of the own vehicle but also the driver of the other vehicle can be prevented from determining a precedence relationship between roads erroneously.

The thirteenth embodiment shows the example of using the three projection patterns responsive to the case where an own vehicle traveling road is given precedence, the case where a connected road is given precedence, and the case where the own vehicle traveling road and the connected road have the same precedence or a precedence relationship between these roads is unknown. In the present invention, however, at least two or more projection patterns are required to be used.

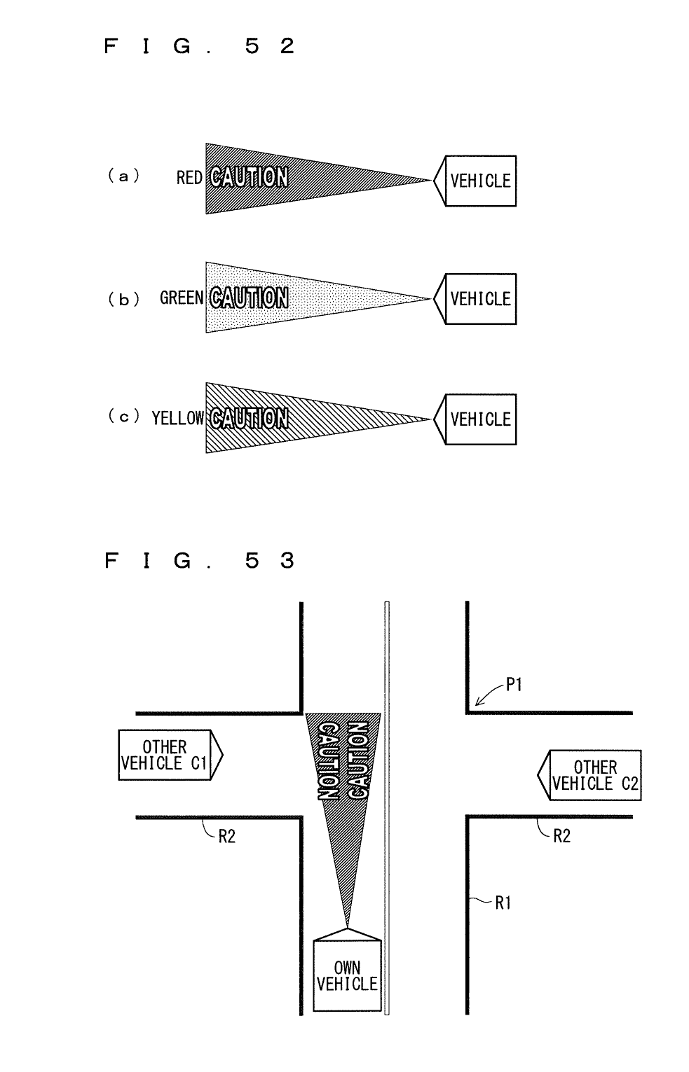

For example, like in the case where the own vehicle traveling road R1 is given precedence (FIG. 53), the projection controller 11 may select the first projection pattern (red) in the case shown in FIG. 58 where the own vehicle traveling road R1 and the connected road R2 have the same precedence or a precedence relationship between these roads is unknown. FIG. 59 is a flowchart showing the projection pattern deciding process (step S32 of FIG. 56) employed if a projection pattern is selected in this way. The flowchart of FIG. 59 is the same as that of FIG. 57, except that the flow shifts to step S322 of deciding to employ the first projection pattern (red) if the own vehicle traveling road and the connected road are determined to have the same precedence or a precedence relationship between these roads is determined to be unknown in step S321. Thus, the flowchart of FIG. 59 will not be described in detail.

Referring to FIG. 49, the precedence relationship determining part 19 is provided in the vehicle projection control device 10 having the structure of the first embodiment (FIG. 1). The precedence relationship determining part 19 determines a precedence relationship between roads based on the map information stored in the map information storage 22. However, the process of determining a precedence relationship between roads by the precedence relationship determining part 19 can be performed in a different way.

For example, if an infrastructure such as a beacon to distribute traffic information is developed and a distribution facility to distribute position information about a connection point and information about a precedence relationship between roads at this connection point is installed at every place of a road network, each of the processes by the precedence relationship determining part 19 may be performed based on information acquired as a result of communication with each distribution facility. In this case, the precedence relationship determining part 19 may be provided in the vehicle projection control device 10 shown in FIG. 14 and the precedence relationship determining part 19 may determine a precedence relationship between an own vehicle traveling road and a connected road based on information about a precedence relationship between roads acquired by the communication device 23 from the distribution facility, for example.

As another example, the precedence relationship determining part 19 may determine a precedence relationship between roads based on a result of analysis on an image of a surrounding of an own vehicle taken by an on-board camera. In this case, the precedence relationship determining part 19 may be provided in the vehicle projection control device 10 shown in FIG. 15 and the precedence relationship determining part 19 may determine a precedence relationship between an own vehicle traveling road and a connected road based on a result of analysis on an image in the image taken by the on-board camera, for example.

As another example, the precedence relationship determining part 19 may determine a precedence relationship between roads based on information acquired by an on-board sensor. In this case, the precedence relationship determining part 19 may be provided in the vehicle projection control device 10 shown in FIG. 16 and the precedence relationship determining part 19 may determine a precedence relationship between an own vehicle traveling road and a connected road based on a result of analysis on sensor information, for example.

### Fourteenth Embodiment

In the illustrations of FIGS. 22 and 23 referred to previously, the vehicle projection control device 10 projects a graphic object, indicating time to elapse before an own vehicle reaches a connection point ahead of the own vehicle in a traveling direction (hereinafter called “remaining time”), to an overlapping traveling area at the connection point by using the projection device 20. Such a graphic image is not limited to those shown in FIGS. 22 and 23. This embodiment shows modifications of the graphic object indicating remaining time. The exemplary graphic objects described below are also usable for the purpose of showing a distance from an own vehicle to a connection point.

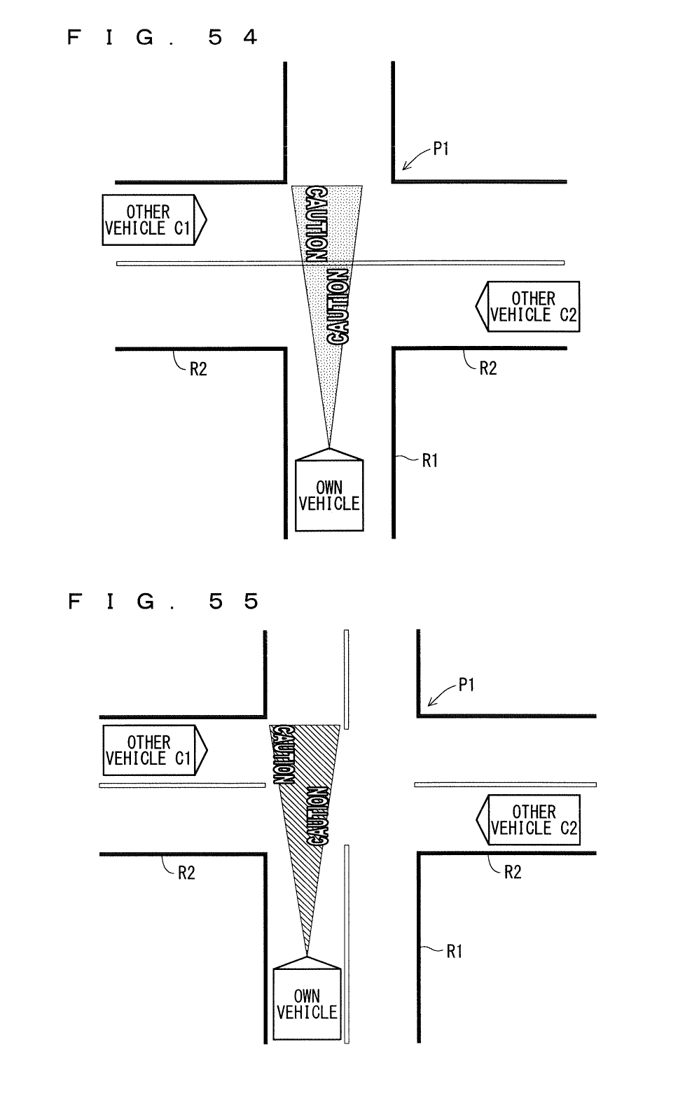

In the illustrations of FIGS. 23 and 23, a graphic object indicating remaining time is formed of a rectangular graphic object (hereinafter called a “bar”) as a constituent element (hereinafter called an “elemental graphic object”) and remaining time is indicated by the number of bars, as shown in FIG. 60. In the illustrations of FIGS. 22 and 23, the breadth (width) of each bar is constant. Alternatively, as shown in FIG. 61, each bar may become thicker in response to reduction in the number of bars. Thickening a bar in response to reduction in remaining time can show that a degree of tension is increasing. Increasing a total area of bars in response to reduction in the number of bars acts more effectively.

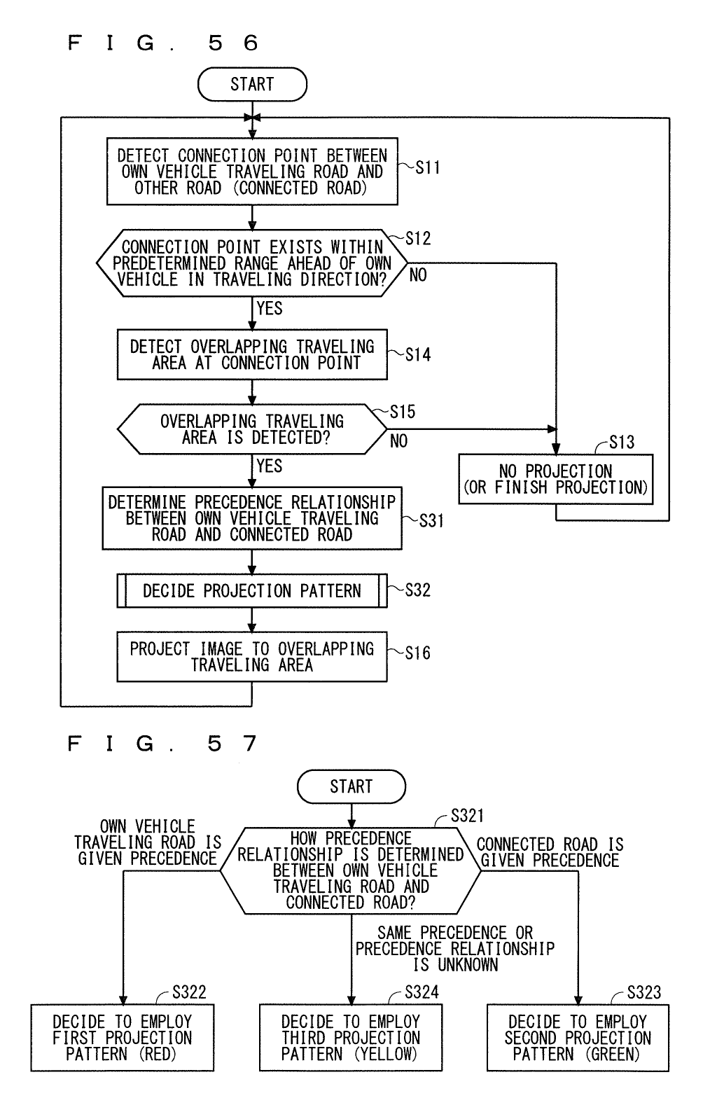

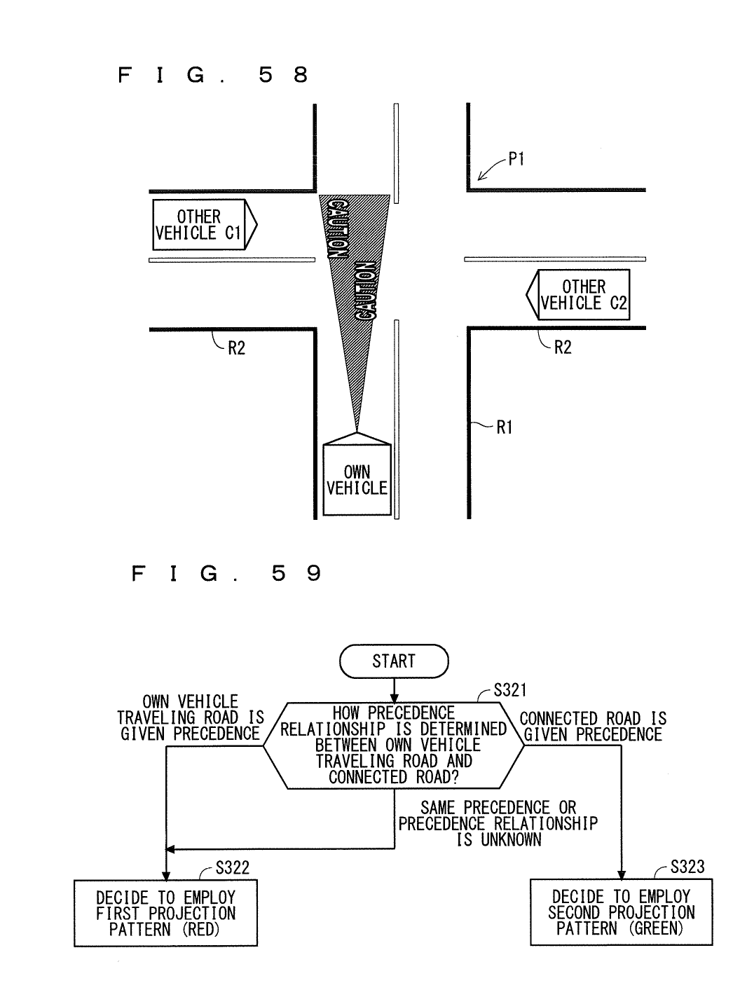

As shown in FIG. 62, even with reduction in the number of bars, the width of an entire region for drawing of bars may still be maintained, for example. As shown in FIG. 63, for reducing the number of bars, adjacent bars may be connected while the position of each bar is maintained, for example. Not changing the position of each bar achieves continuous change of an image, so that change in the number of bars can be recognized more easily. Additionally, as shown in FIG. 64, adjacent bars may be connected in an animated way to show that an interval between the bars to be connected is reduced gradually. Alternatively, as shown in FIG. 65, two bars may be connected by changing the color of a region between the bars to be connected and then changing the color of this region to the same color as the bars.

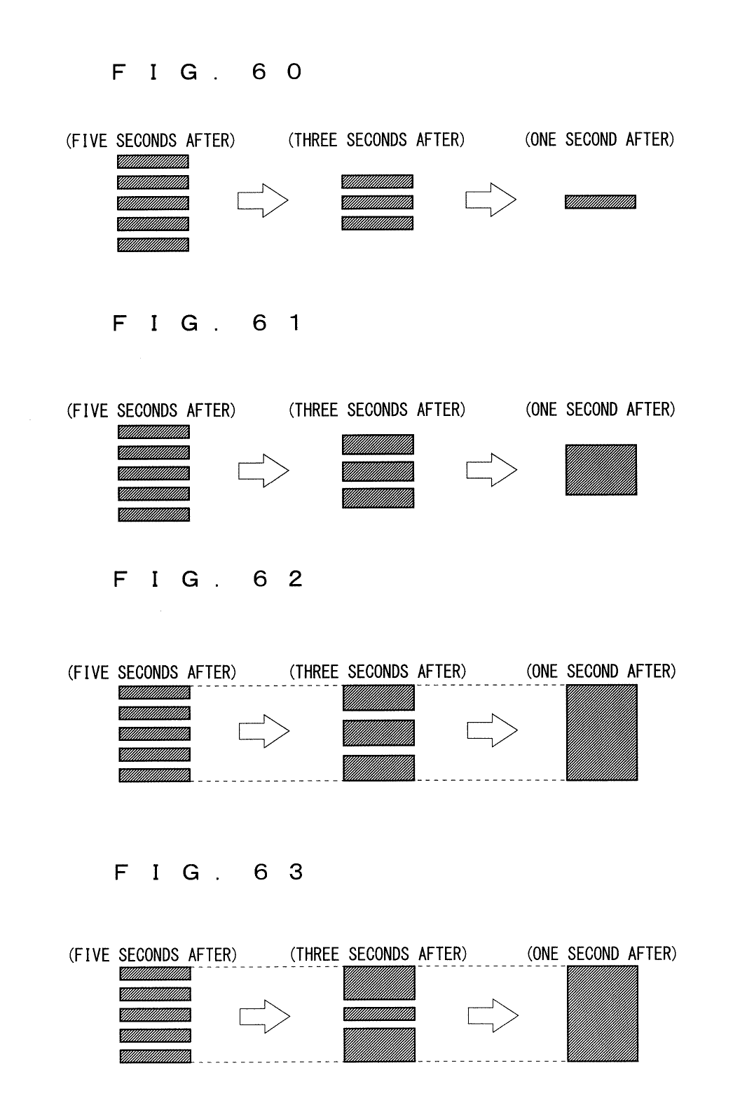

Referring to FIGS. 22 and 23, vertically-long bars are aligned in a horizontal direction as viewed from another vehicle. Conversely, horizontally-long bars may be aligned in a vertical direction as viewed from another vehicle. FIGS. 66 and 67 show examples of using horizontally-long bars as viewed from another vehicle (dotted arrows of FIGS. 66 and 67 show directions of a line of sight from another vehicle). FIG. 66 shows that one of a plurality of bars is longer than the other bars and remaining time is shown by the position of the longest bar (the number of bars is constant). In response to reduction in remaining time, the longest bar moves in such a way as to approach another vehicle. In this way, a driver of the other vehicle can intuitively recognize that a degree of tension is increasing. As shown in FIG. 67, the position of the longest bar can be moved while the number of bars is reduced in a manner that depends on remaining time.

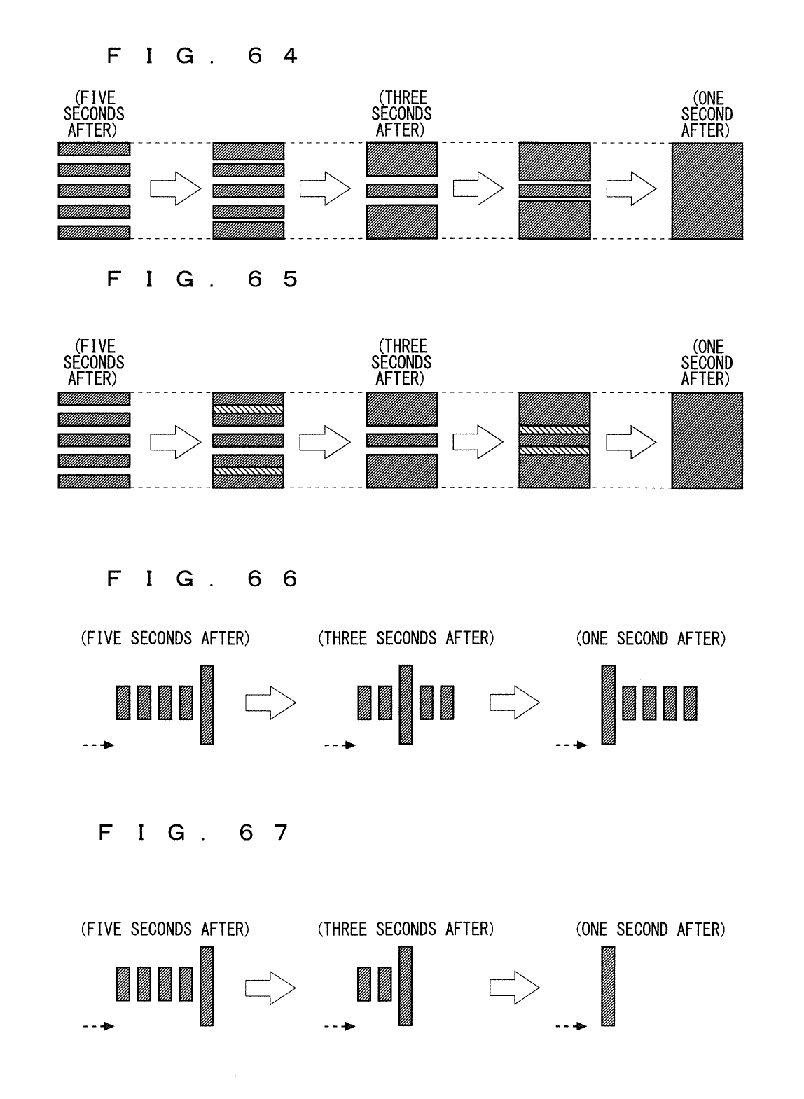

A constituent element (elemental graphic object) forming a graphic object indicating remaining time is not limited to a rectangular bar. As shown in FIG. 68, sector-form elemental graphic objects may be used, for example. In this case, not only the number of sectors or the breadth of each sector but also the radius of a sector may be changed in a manner that depends on remaining time. For example, thickening a sector or increasing the radius of a sector in response to reduction in remaining time can show that a degree of tension is increasing.

For use of a plurality of elemental graphic objects, these elemental graphic objects are not always required to be aligned in one direction. For example, FIG. 69 shows an example of using a plurality of circular elemental graphic objects concentric with each other. In this example, a circle may be thickened or the radius of a circle may be increased for reducing the number of elemental graphic objects in a manner that depends on remaining time. Alternatively, a plurality of concentric rectangles or a plurality of concentric polygons can be used as elemental graphic objects.

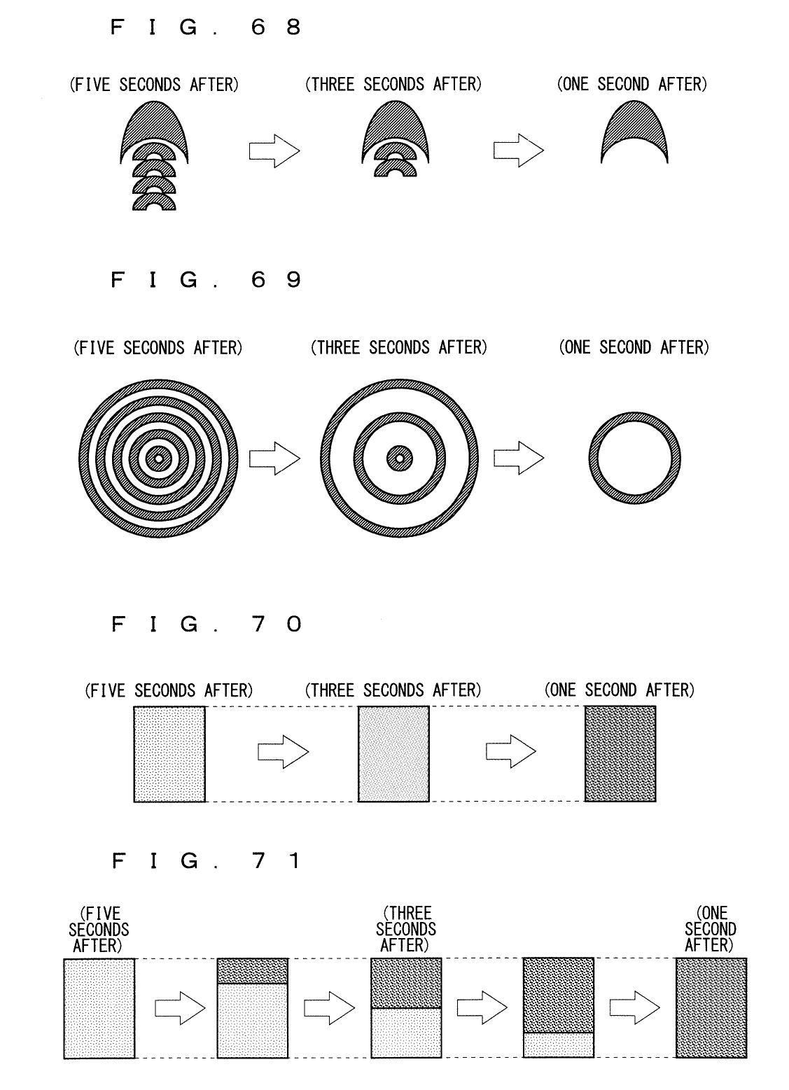

As shown in FIG. 70, remaining time may be shown not by the number of elemental graphic objects or the shape of an elemental graphic object but also by the color, design, or brightness of an elemental graphic object. In this case, an elemental graphic object may be shown more remarkably in response to reduction in remaining time. For example, an elemental graphic object may be changed in the following way: pale pink at five seconds before, dark pink at three seconds before, and red at one second before. As shown in FIG. 71, an elemental graphic object may also be changed partially in terms of color or design. In response to reduction in remaining time, the area of a remarkable part (a part in dark color, for example) may be increased.

The embodiments of the present invention can be combined freely, or each of the embodiments can be changed or omitted, where appropriate, within the scope of the invention.

While the invention has been shown and described in detail, the foregoing description is in all aspects illustrative and not restrictive. It is therefore understood that numerous modifications and variations can be devised without departing from the scope of the invention.

### REFERENCE SIGNS LIST

10 Vehicle projection control device
11 Projection controller
12 Connection point detector
13 Overlapping traveling area detector
14 Own vehicle position specifying part
15 Planned traveling route acquiring part
16 Other vehicle detector
17 Other vehicle traveling direction estimating part
18 Connection angle determining part
19 Precedence relationship determining part
101 Warning part
102 Traveling controller
20 Projection device
21 Position information acquiring device
22 Map information storage
23 Communication device
24 On-board camera
25 On-board sensor
26 Vehicle driver

1.-27. (canceled)

28. A vehicle projection control system comprising:
a processor to execute a program; and
a memory to store the program which, when executed by said processor, performs processes of:
controlling a projection device to project an image to a surrounding of an own vehicle;
specifying a position of said own vehicle on a map based on map information;
detecting a connection point between an own vehicle traveling road on which said own vehicle is traveling and a connected road that is another road connected to said own vehicle traveling road based on said map information and said position of said own vehicle on said map;
detecting an overlapping traveling area at said connection point, said overlapping traveling area being an area that permits traveling of both another vehicle to enter said connection point from a connected road and said own vehicle based on said map information and said position of said own vehicle on said map; and
projecting an image to said overlapping traveling area detected in said detecting of an overlapping traveling area by using said projection device.

29. The vehicle projection control system according to claim 28, wherein
said processor detects an overlapping traveling area based on regulation on a traveling direction of a vehicle at a connection point.

30. The vehicle projection control system according to claim 28, wherein
said processor acquires a planned traveling route of said own vehicle, and
detects an overlapping traveling area on said acquired planned traveling route of said own vehicle.

31. The vehicle projection control system according to claim 28, wherein
said processor detects the existence of another vehicle traveling on a connected road toward a connection point, estimates a traveling direction of said detected another vehicle at a connection point, and detects an overlapping traveling area based on said estimated traveling direction of said another vehicle at said connection point.

32. The vehicle projection control system according to claim 28, wherein
said processor makes said projection device project an image toward an overlapping traveling area at a connection point existing ahead of said own vehicle in a traveling direction.

33. The vehicle projection control system according to claim 32, wherein
said processor further detects a distance from said own vehicle to a connection point, and
makes said projection device project an image toward an overlapping traveling area at a connection point existing in a predetermined range from said own vehicle.

34. The vehicle projection control system according to claim 28, wherein
said processor is capable of detecting a plurality of overlapping traveling areas, and makes said projection device project an image toward each of said plurality of overlapping traveling areas detected.

35. The vehicle projection control system according to claim 28, wherein
said processor is capable of detecting a plurality of connection points, detects an overlapping traveling area at each of said plurality of connection points, and makes said projection device project an image toward said overlapping traveling area at each of said plurality of connection points.

36. The vehicle projection control system according to claim 28, wherein
if an own vehicle traveling road has a plurality of lanes, said processor makes said projection device project an image to only a lane in which said own vehicle is traveling.

37. The vehicle projection control system according to claim 28, wherein
if there is an opposite lane opposite to an own vehicle traveling road, said processor does not make said projection device project an image to said opposite lane.

38. The vehicle projection control system according to claim 28, wherein
processor acquires position information about a connection point between an own vehicle traveling road and a connected road through external communication, and
acquires position information about an overlapping traveling area through external communication.

39. The vehicle projection control system according to claim 28, wherein
said processor detects a connection point between an own vehicle traveling road and a connected road based on an image taken by a camera on said own vehicle or information acquired by a sensor on said own vehicle, and detects an overlapping traveling area based on said image taken by said camera on said own vehicle or said information acquired by said sensor on said own vehicle.

40. The vehicle projection control system according to claim 28, wherein
said processor makes said projection device project an image that includes an image of a character, an image of a symbol, or an image of a code.

41. The vehicle projection control system according to claim 40, wherein
said processor changes a style of display of said image in a manner that depends on a distance from said own vehicle to a connection point or an overlapping traveling area or time to elapse before said own vehicle reaches said connection point or said overlapping traveling area.

42. The vehicle projection control system according to claim 40, wherein
said processor determines a connection angle of a connected road to an own vehicle traveling road based on said map information,
for projection of an image to a connection point by using said projection device, said processor adjusts the orientation of said image to be projected in a manner that depends on a connection angle between an own vehicle traveling road and a connected road at said connection point to place an image to be projected by said projection device in an orientation in which a character, a symbol, or a code included in said image is viewed correctly from said connected road.

43. The vehicle projection control system according to claim 40, wherein
said processor determines a precedence relationship between an own vehicle traveling road and a connected road at a connection point based on said map information,
for projection of an image to a connection point by using said projection device, said processor changes a projection pattern of said image in a manner that depends on a precedence relationship between an own vehicle traveling road and a connected road at said connection point, and defines a first projection pattern and a second projection pattern differing from each other, said first projection pattern being a projection pattern of an image to be projected to a connection point employed if an own vehicle traveling road is given precedence over a connected road at said connection point, said second projection pattern being a projection pattern of an image to be projected to a connection point employed if a connected road is given precedence over an own vehicle traveling road at said connection point.

44. The vehicle projection control system according to claim 28, wherein
said processor detects the existence of another vehicle traveling on a connected road toward a connection point, and
detects an overlapping traveling area that permits traveling of said another vehicle detected.

45. The vehicle projection control system according to claim 44, wherein
said processor issues a warning to a driver if said another vehicle detected and said own vehicle are determined to enter the same overlapping traveling area simultaneously, or
makes said own vehicle decelerate or makes a temporary stop if said another vehicle detected and said own vehicle are determined to enter the same overlapping traveling area simultaneously.

46. A method of controlling image projection employed by a vehicle projection control system, said method comprising:
specifying a position of an own vehicle on a map based on map information, said specifying being performed by an own vehicle position specifying part of said projection control system;
detecting a connection point between an own vehicle traveling road on which an own vehicle is traveling and a connected road that is another road connected to said own vehicle traveling road, said detecting being performed by a connection point detector of said projection control system detects;
detecting an overlapping traveling area at said connection point based on said map information and said position of said own vehicle on said map, said overlapping traveling area being an area that permits traveling of both another vehicle to enter said connection point from a connected road and said own vehicle, said detecting being performed by an overlapping traveling area detector of said projection control system detects; and
projecting an image to said overlapping traveling area by using a projection device, said projecting being performed by a projection controller of said projection control system.
